(19) United States
(12) Patent Application Publication
(10) Pub. No.: US 2009/0128902 A1
(43) Pub. Date: May 21, 2009

(54) Binocular Optical Relay Device

(76) Inventors: Yehuda Niv, Nes Ziona (IL); Amir Beker, Rosh HaAyin (IL)

Correspondence Address: Martin D. Moynihan;PRTSI, P.O. Box 16446, Arlington, VA, 22215, US

(21) Appl. No.: 11/992,892

(22) PCT Filed: Oct. 31, 2006
(86) PCT No.: PCT/IL2006/001257

§ 371 Date: Mar. 31, 2008

Related U.S. Application Data
(60) Provisional application No. 60/732,661, filed on Nov. 3, 2005.

(51) Int. Cl. G02B 23/04

(52) U.S. Cl. 359/482; 264/2.5

(57) ABSTRACT

An optical relay device, comprising a light-transmissive substrate shaped as a structure having an apex section, a right section and a left section being separated from the right section by an air gap. The optical relay device further comprises at least two input optical elements located at the apex section, a right output optical element located at the right section, and a left output optical element located at the left section. The substrate and the optical elements are designed and constructed such that light is redirected by the input optical elements, propagates via total internal reflection in the direction of at least one of the sections, and redirected out of the substrate by at least one output optical element.

### FIELD AND BACKGROUND OF THE INVENTION

The present invention relates to optics, and, more particularly, to a binocular optical relay device and system capable of providing monochrome or multicolor images.

Miniaturization of electronic devices has always been a continuing objective in the field of electronics. Electronic devices are often equipped with some form of a display, which is visible to a user. As these devices reduce in size, there is an increase need for manufacturing compact displays, which are compatible with small size electronic devices. Besides having small dimensions, such displays should not sacrifice image quality, and be available at low cost. By definition the above characteristics are conflicting and many attempts have been made to provide some balanced solution.

An electronic display may provide a real image, the size of which is determined by the physical size of the display device, or a virtual image, the size of which may extend the dimensions of the display device.

A real image is defined as an image, projected on or displayed by a viewing surface positioned at the location of the image, and observed by an unaided human eye (to the extent that the viewer does not require corrective glasses). Examples of real image displays include a cathode ray tube (CRT), a liquid crystal display (LCD), an organic light emitting diode array (OLED), or any screen-projected displays. A real image could be viewed normally from a distance of about at least 25 cm, the minimal distance at which the human eye can utilize focus onto an object. Unless a person is long-sighted, he may not be able to view a sharp image at a closer distance.

Typically, desktop computer systems and workplace computing equipment utilize CRT display screens to display images for a user. The CRT displays are heavy, bulky and not easily miniaturized. For a laptop, a notebook, or a palm computer, flat-panel display is typically used. The flat-panel display may use LCD technology implemented as passive matrix or active matrix panel. The passive matrix LCD panel consists of a grid of horizontal and vertical wires. Each intersection of the grid constitutes a single pixel, and controls an LCD element. The LCD element either allows light through or blocks the light. The active matrix panel uses a transistor to control each pixel, and is more expensive.

An OLED flat panel display is an array of light emitting diodes, made of organic polymeric materials. Existing OLED flat panel displays are based on both passive and active configurations. Unlike the LCD display, which controls light transmission or reflection, an OLED display emits light, the intensity of which is controlled by the electrical bias applied thereto. Flat-panels are also used for miniature image display systems because of their compactness and energy efficiency compared to the CRT displays. Small size real image displays have a relatively small surface area on which to present a real image, thus have limited capability for providing sufficient information to the user. In other words, because of the limited resolution of the human eye, the amount of details resolved from a small size real image might be insufficient.

By contrast to a real image, a virtual image is defined as an image, which is not projected onto or emitted from a viewing surface, and no light ray connects the image and an observer. A virtual image can only be seen through an optic element, for example a typical virtual image can be obtained from an object placed in front of a converging lens, between the lens and its focal point. Light rays, which are reflected from an individual point on the object, diverge when passing through the lens, thus no two rays share two endpoints. An observer, viewing from the other side of the lens would perceive an image, which is located behind the object, hence enlarged. A virtual image of an object, positioned at the focal plane of a lens, is said to be projected to infinity. A virtual image display system, which includes a miniature display panel and a lens, can enable viewing of a small size, but high content display, from a distance much smaller than 25 cm. Such a display system can provide a viewing capability which is equivalent to a high content, large size real image display system, viewed from much larger distance.

Conventional virtual image displays are known to have many shortcomings. For example, such displays have suffered from being too heavy for comfortable use, as well as too large so as to be obtrusive, distracting and even disorienting. These defects stem from, inter alia, the incorporation of relatively large optics systems within the mounting structures, as well as physical designs which fail to adequately take into account important factors as size, shape, weight, etc.

Recently, holographic optical elements have been used in portable virtual image displays. Holographic optical elements serve as an imaging lens and a combiner where a two-dimensional, quasi-monochromatic display is imaged to infinity and reflected into the eye of an observer. A common problem to all types of holographic optical elements is their relatively high chromatic dispersion. This is a major drawback in applications where the light source is not purely monochromatic. Another drawback of some of these displays is the lack of coherence between the geometry of the image and the geometry of the holographic optical element, which causes aberrations in the image array that decrease the image quality.

New designs, which typically deal with a single holographic optical element, compensate for the geometric and chromatic aberrations by using non-spherical waves rather than simple spherical waves for recording; however, they do not overcome the chromatic dispersion problem. Moreover, with these designs, the overall optical systems are usually very complicated and difficult to manufacture. Furthermore, the field-of-view resulting from these designs is usually very small.

U.S. Pat. No. 4,711,512 to Upatnieks, the contents of which are hereby incorporated by reference, describes a diffractive planar optics head-up display configured to transmit collimated light wavefronts of an image, as well as to allow light rays coming through the aircraft windscreen to pass and be viewed by the pilot. The light wavefronts enter an elongated optical element located within the aircraft cockpit through a first diffractive element, are diffracted into total internal reflection within the optical element, and are diffracted out of the optical element by means of a second diffractive element into the direction of the pilot's eye while retaining the collimation. Upatnieks, however, does not teach how the display could transmit a wide field-of-view, or tackle a broad spectrum of wavelengths (for providing color images).

U.S. Pat. No. 5,966,223 to Friesem et al., the contents of which are hereby incorporated by reference describes a holographic optical device similar to that of Upatnieks, with the additional aspect that the first diffractive optical element acts further as the collimating element that collimates the waves emitted by each data point in a display source and corrects for field aberrations over the entire field-of-view. The field-of-view discussed is ±6°, and there is a further discussion of low chromatic sensitivity over wavelength shift of Δλ_{c} of ±2 nm around a center wavelength λ_{c} of 632.8 nm. However, the diffractive collimating element of Friesem et al. is known to narrow spectral response, and the low chromatic sensitivity at spectral range of ±2 nm becomes an unacceptable sensitivity at ±20 nm or ±70 nm.

U.S. Pat. No. 6,757,105 to Niv et al., the contents of which are hereby incorporated by reference, provides a diffractive optical element for optimizing a field-of-view for a multicolor spectrum. The optical element includes a light-transmissive substrate and a linear grating formed therein. Niv et al. teach how to select the pitch of the linear grating and the refraction index of the light-transmissive substrate so as to trap a light beam having a predetermined spectrum and characterized by a predetermined field of view to propagate within the light-transmissive substrate via total internal reflection. Niv et al. also disclose an optical device incorporating the aforementioned diffractive optical element for transmitting light in general and images in particular into the eye of the user.

The above prior art virtual image devices, however, provide a single optical channel, hence allowing the scene of interest to be viewed by one eye. It is recognized that the ability of any virtual image devices to transmit an image without distortions inherently depends on whether or not light rays emanating from all points of the image are successfully transmitted to the eye of the user in their original wavelength. Due to the single optical channel employed by presently known devices, the field-of-view which can be achieved without distortions or loss of information is rather limited.

The above virtual image devices, however, provide a single optical channel, hence allowing the scene of interest to be viewed by one eye. It is recognized that the ability of any virtual image devices to transmit an image without distortions inherently depends on whether or not light rays emanating from all points of the image are successfully transmitted to the eye of the user in their original color. Due to the single optical channel employed by presently known devices, the filed-of-view which can be achieved without distortions or loss of information is rather limited. Furthermore, a single optical channel cannot provide a stereoscopic image.

A binocular device which employs several diffractive optical elements is disclosed in U.S. patent application Ser. Nos. 10/896,865 and 11/017,920, and in International Patent Application, Publication No. WO 2006/008734, the contents of which are hereby incorporated by reference. An optical relay is formed of a light transmissive substrate, an input diffractive optical element and two output diffractive optical elements. Collimated light is diffracted into the optical relay by the input diffractive optical element, propagates in the substrate via total internal reflection and coupled out of the optical relay by two output diffractive optical elements. The input and output diffractive optical elements preserve relative angles of the light rays to allow transmission of images with minimal or no distortions. The output elements are spaced apart such that light diffracted by one element is directed to one eye of the viewer and light diffracted by the other element is directed to the other eye of the viewer. The binocular design of these references significantly improves the field-of-view. The images provided by the above systems are viewed by the user as planar images.

U.S. Pat. No. 6,882,479 to Song et al. discloses a wearable display system for producing a “three-dimensional” image. The display includes a display panel which outputs an optical signal and a waveguide which guides the propagation of the signal. The signal is diffracted out of the waveguide by two gratings, and magnified by magnifying lenses. Two shutters are used for alternately blocking the outgoing light. The wearable display system operates on the principle that a three-dimensional effect is realized when the same image reaches the eyes of the user with a time difference.

Although some of the above techniques provide wide field-of-view images, their practical implementation require the use of two image sources, one for each eye, and/or positioning the viewing device at a considerable distance from the eyes of the user to maintain free optical path between the image source(s) and the optical relay.

The present invention provides solutions to the problems associated with prior art binocular devices.

### SUMMARY OF THE INVENTION

According to one aspect of the present invention there is provided an optical relay device. The optical relay device comprises a light-transmissive substrate shaped as a structure having an apex section, a right section and a left section being separated from the right section by an air gap. The optical relay device further comprises at least two input optical elements located at the apex section, a right output optical element located at the right section, and a left output optical element located at the left section. The substrate and the optical elements of the optical relay device are designed and constructed such that light is redirected by the input optical elements, propagates via total internal reflection in the direction of the left and/or right sections, and redirected out of the light-transmissive substrate by the left and/or right output optical elements.

According to another aspect of the present invention there is provided a system for generating and transmitting an image. The system comprises the optical relay device and an image generating system for providing the optical relay device with collimated light constituting the image.

According to further features in preferred embodiments of the invention described below, each of the optical elements comprises a linear grating. According to still further features in the described preferred embodiments the input optical elements comprise a blazed linear grating.

According to still further features in the described preferred embodiments the device further comprises an additional optical element positioned at the apex section and configured for reducing optical cross-talks between the input optical elements.

According to yet another aspect of the present invention there is provided a method of manufacturing an optical relay device. The method comprises: forming a mold configured to receive a light transmissive material and to shape the material as a structure having the apex, right and left sections as described herein. The mold is patterned according to inverted shapes of: at least two central linear gratings located at the apex section, a right linear grating located at the right section, and a left linear grating located at the left section. The method further comprises contacting the mold with the light transmissive material, so as to provide a light-transmissive substrate shaped as the structure and formed with the central, right and left linear gratings.

According to further features in preferred embodiments of the invention described below, the mold is also configured to form an additional optical element at the apex section. The additional optical element serves for reducing optical cross-talks between the central linear gratings.

According to still another aspect of the present invention there is provided a method of manufacturing an optical relay device. The method comprises: cutting a light transmissive substrate to form a structure having the apex, right and left sections as described herein. The method further comprises forming a mold patterned according to an inverted shape of at least one linear grating, and contacting the mold(s) with the structure, so as to form central, right and left linear gratings as described herein.

According to further features in preferred embodiments of the invention described below, the method further comprises attaching an additional optical element to the light transmissive substrate at the apex section. The additional optical element serves for reducing optical cross-talks between the central linear gratings.

According to still further features in the described preferred embodiments two central linear gratings are designed and constructed as input optical elements capable of redirecting light rays striking the light transmissive substrate into the light transmissive substrate such that at least one light ray of the light rays propagates within the light-transmissive substrate via total internal reflection. According to still further features in the described preferred embodiments the central linear gratings comprise blazed linear gratings.

According to still further features in the described preferred embodiments each of the right and the left linear gratings are designed and constructed as output optical elements capable of redirecting light rays propagating within the light transmissive substrate out of the light transmissive substrate.

According to still further features in the described preferred embodiments the additional optical element comprises a light absorber.

According to still further features in the described preferred embodiments the additional optical element comprises a light scatterer.

According to still further features in the described preferred embodiments the additional optical element comprises a light diffuser.

According to still further features in the described preferred embodiments the structure is generally a chevron or a crescent.

According to still further features in the described preferred embodiments the input linear gratings comprise a right input linear grating and a left input linear grating, wherein the right and left input linear gratings are characterized by periodic linear structures having similar periods and different orientations.

According to still further features in the described preferred embodiments the left input linear grating and the left output linear grating are characterized by periodic linear structures having similar periods and similar orientations. According to still further features in the described preferred embodiments the right input linear grating and the right output linear grating are characterized by periodic linear structures having similar periods and similar orientations.

According to still further features in the described preferred embodiments the left output optical element is designed and constructed for redirecting light striking the light transmissive substrate at any angle within a predetermined field-of-view out of the light-transmissive substrate. According to still further features in the described preferred embodiments the right output optical element is designed and constructed for redirecting light striking the light transmissive substrate at any angle within the predetermined field-of-view out of the light-transmissive substrate.

According to still further features in the described preferred embodiments each of the left and the right output optical element is characterized by planar dimensions selected such that at least a portion of at least one outermost light ray within the predetermined field-of-view is redirected by the left output optical element into a first two-dimensional region, and at least a portion of at least one outermost light within the predetermined field-of-view is redirected by the right output optical element into a second two-dimensional region.

According to still further features in the described preferred embodiments the left output optical element is designed and constructed for redirecting light striking the light transmissive substrate at any angle within a first partial field-of-view out of the light-transmissive substrate. According to still further features in the described preferred embodiments the right output optical element is designed and constructed for redirecting light striking the light transmissive substrate at any angle within a second partial field-of-view out of the light-transmissive substrate.

According to still further features in the described preferred embodiments the first partial field-of-view and the second partial field-of-view are different. According to still further features in the described preferred embodiments the first partial field-of-view and the second partial field-of-view are partially overlapped.

According to still further features in the described preferred embodiments the left output optical element is characterized by planar dimensions selected such that at least a portion of at least one outermost light ray within the first partial field-of-view is directed to a first two-dimensional region. According to still further features in the described preferred embodiments the right output optical element is characterized by planar dimensions selected such that at least a portion of at least one outermost light ray within the second partial field-of-view is directed to a second two-dimensional region.

According to still further features in the described preferred embodiments both the first and the second two-dimensional regions are at a predetermined distance from the light transmissive substrate.

According to still further features in the described preferred embodiments a lateral separation Δy between the center of the first two-dimensional region and the center of the second two-dimensional region is at least 40 millimeters. According to still further features in the described preferred embodiments the lateral separation Δy is less than 80 millimeters.

According to still further features in the described preferred embodiments the planar dimensions are selected such that the portions of the outermost light rays are respectively directed to the first and the second two-dimensional regions, for any lateral separation Δy which is larger than 40 millimeters and smaller than 80 millimeters, alternatively Δy is larger than 50 millimeters and smaller than 65 millimeters, alternatively Δy is larger than 53 millimeters and smaller than 73 millimeters, alternatively Δy is larger than 53 millimeters and smaller than 63 millimeters, alternatively Δy is larger than 58 millimeters and smaller than 68 millimeters, alternatively Δy is larger than 63 millimeters and smaller than 73 millimeters.

According to still further features in the described preferred embodiments a width characterizing the planar dimensions of the right and the left output optical elements is smaller than a width characterizing the planar dimensions of the input optical element.

According to still further features in the described preferred embodiments the predetermined distance is from about 15 millimeters to about 35 millimeters.

According to still further features in the described preferred embodiments a width of each of the first two-dimensional region and the second two-dimensional region is from about 4 millimeters to about 9 millimeters.

According to still further features in the described preferred embodiments a length of each of the first two-dimensional region and the second two-dimensional region is from about 5 millimeters to about 13 millimeters.

According to still further features in the described preferred embodiments a length of each of the input optical elements equals from about X to about 3X where X is a minimal unit hop-length characterizing propagation of an outermost light ray within the light transmissive substrate via total internal reflection.

According to still further features in the described preferred embodiments the light is characterized by a spectrum inclusively defined between a shortest wavelength and a longest wavelength.

According to still further features in the described preferred embodiments a length of the input optical element equals from about X to about 3X where X is a unit hop-length characterizing propagation of a light ray having the shortest wavelength within the light transmissive substrate via total internal reflection.

The present invention successfully addresses the shortcomings of the presently known configurations by providing an optical relay device, an optical system and a method for manufacturing the optical relay device. The device, system and method of the present embodiments enjoy properties far exceeding the presently known devices, systems and methods.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of light diffraction by a linear diffraction grating operating in transmission mode;

FIGS. 2A-D are schematic illustrations of a front view in the x-y plane (FIG. 2A), and cross sectional views in the y-z plane (FIGS. 2B-C) and x-z plane (FIG. 2D) of an optical relay device, according to various exemplary embodiments of the present invention;

FIGS. 3A-B are schematic illustrations of a front view (FIG. 3A) and a side view (FIG. 3B) of a preferred positioning of the optical relay device in front of a face of a user, according to various exemplary embodiments of the present invention;

FIGS. 4A-B are fragmentary view illustrating one segment of the optical relay device in a plane parallel to the longitudinal and normal axes (FIG. 4A), and a plane parallel to the transverse and normal axes (FIG. 4B), according to various exemplary embodiments of the present invention;

FIG. 4C is a schematic illustration of a rectangular field-of-view of the optical relay device, according to various exemplary embodiments of the invention;

FIGS. 4D-E are schematic illustrations of field-of-view angles of the optical relay device, according to various exemplary embodiments of the invention;

FIG. 5 is a schematic illustration of the optical relay device of the present embodiments, in which the cross sectional views along lines B-B′ and A-A′ of FIG. 2A are superimposed;

FIGS. 6A-F are schematic illustrations of wavefront propagation within the optical relay device, according to preferred embodiments of the invention in which different partial field-of-views propagate within in different segments of the light transmissive substrate;

FIG. 7 is a schematic illustration of binocular system, according to various exemplary embodiments of the present invention;

FIGS. 8A-D are flowchart diagrams of method steps suitable for manufacturing the optical relay device, according to various exemplary embodiments of the present invention;

FIGS. 9A-L are schematic process illustrations describing various manufacturing steps of the optical relay device, according to various exemplary embodiments of the present invention; and

FIG. 10 is a schematic illustration of a top view of a cavity of a mold which can be used for manufacturing the optical relay device, according to various exemplary embodiments of the present invention.

### DESCRIPTION OF THE PREFERRED EMBODIMENTS

The present embodiments comprise binocular optical relay device and system which can be used for transmitting light. Specifically, but not exclusively, the present embodiments can be used for providing virtual images. The present embodiments can be used in many applications in which virtual images are viewed, including, without limitation, eyeglasses, binoculars, head mounted displays, head-up displays, cellular telephones, personal digital assistants, aircraft cockpits and the like. The present embodiments further comprise a method suitable for manufacturing the optical relay device.

The principles and operation of a device and system according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

When a ray of light moving within a light-transmissive substrate and striking one of its internal surfaces at an angle φ₁ as measured from a normal to the surface, it can be either reflected from the surface or refracted out of the surface into the open air in contact with the substrate. The condition according to which the light is reflected or refracted is determined by Snell's law, which is mathematically realized through the following equation:

n_{A} sin φ₂=n_{S} sin φ₁, (EQ. 1)

where n_{S} is the index of refraction of the light-transmissive substrate, n_{A} is the index of refraction of the medium outside the light transmissive substrate (n_{S}>n_{A}), and φ₂ is the angle in which the ray is refracted out, in case of refraction. Similarly to φ₁, φ₂ is measured from a normal to the surface. A typical medium outside the light transmissive substrate is air having an index of refraction of about unity.

As used herein, the term “about” refers to ±10%.

As a general rule, the index of refraction of any substrate depends on the specific wavelength λ of the light which strikes its surface. Given the impact angle, φ₁, and the refraction indices, n_{S} and n_{A}, Equation 1 has a solution for φ₂ only for φ₁ which is smaller than arcsine of n_{A}/n_{S} often called the critical angle and denoted α_{c}. Hence, for sufficiently large φ₁ (above the critical angle), no refraction angle φ₂ satisfies Equation 1 and light energy is trapped within the light-transmissive substrate. In other words, the light is reflected from the internal surface as if it had stroked a mirror. Under these conditions, total internal reflection is said to take place. Since different wavelengths of light (i.e., light of different colors) correspond to different indices of refraction, the condition for total internal reflection depends not only on the angle at which the light strikes the substrate, but also on the wavelength of the light. In other words, an angle which satisfies the total internal reflection condition for one wavelength may not satisfy this condition for a different wavelength.

When a sufficiently small object or sufficiently small opening in an object is placed in the optical path of light, the light experiences a phenomenon called diffraction in which light rays change direction as they pass around the edge of the object or at the opening thereof. The amount of direction change depends on the ratio between the wavelength of the light and the size of the object/opening. In planar optics there is a variety of optical elements which are designed to provide an appropriate condition for diffraction. Such optical elements are typically manufactured as diffraction gratings which are located on a surface of a light-transmissive substrate. Diffraction gratings can operate in transmission mode, in which case the light experiences diffraction by passing through the gratings, or in reflective mode in which case the light experiences diffraction while being reflected off the gratings

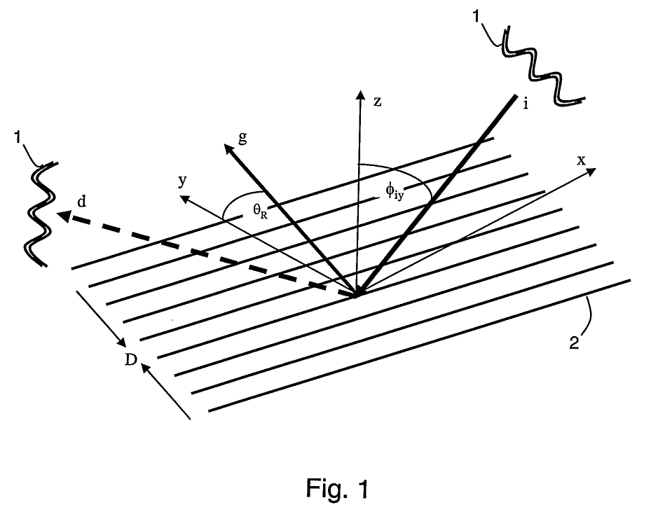

FIG. 1 schematically illustrates diffraction of light by a linear diffraction grating operating in transmission mode. One of ordinary skills in the art, provided with the details described herein would know how to adjust the description for the case of reflection mode.

A wavefront 1 of the light propagates along a vector i and impinges upon a grating 2 engaging the x-y plane. The normal to the grating is therefore along the z direction and the angle of incidence of the light φᵢ is conveniently measured between the vector i and the z axis. In the description below, φᵢ is decomposed into two angles, φᵢₓ and φ_{iy} where φᵢₓ is the incidence angle in the z-x plane, and φ_{iy} is the incidence angle in the z-y plane. For clarity of presentation, only φ_{iy} is illustrated in FIG. 1.

The grating has a periodic linear structure along a vector g, forming an angle θ_{R} with the y axis. The period of the grating (also known as the grating pitch) is denoted by D. The grating is formed on a light transmissive substrate having an index of refraction denoted by n_{S}.

Following diffraction by grating 2, wavefront 1 changes its direction of propagation. The principal diffraction direction which corresponds to the first order of diffraction is denoted by d and illustrated as a dashed line in FIG. 1. Similarly to the angle of incidence, the angle of diffraction φ_{d}, is measured between the vector d and the z axis, and is decomposed into two angles, φ_{dx} and φ_{dy}, where φ_{dx} is the diffraction angle in the z-x plane, and φ_{dy} is the diffraction angle in the z-y plane.

The relation between the grating vector g, the diffraction vector d and the incident vector i can therefore be expressed in terms of five angles (θ_{R}, φᵢₓ, _{iy}, φ_{dx} and φ_{dy}) and it generally depends on the wavelength λ of the light and the grating period D through the following pair of equations:

sin(φᵢₓ)−n_{S} sin(φ_{dx})=(λ/D) sin(θ_{R}) (EQ. 2)

sin(φ_{iy})+n_{S} sin(θ_{dy})=(λ/D) cos(θR). (EQ. 3)

Without the loss of generality, the Cartesian coordinate system can be selected such that the vector i lies in the y-z plane, hence sin(φᵢₓ)=0. In the special case in which the vector g lies along the y axis, θ_{R}=0° or 180°, and Equations 2-3 reduce to the following one-dimensional grating equation:

sin φ_{iy}+n_{S} sin φ_{dy}=±λ/d. (EQ. 4)

According the known conventions, the sign of φᵢₓ, φ_{iy}, φ_{dx} and φ_{dy} is positive, if the angles are measured clockwise from the normal to the grating, and negative otherwise. The dual sign on the RHS of the one-dimensional grating equation relates to two possible orders of diffraction, +1 and −1, corresponding to diffractions in opposite directions, say, “diffraction to the right” and “diffraction to the left,” respectively.

A light ray, entering a substrate through a grating, impinge on the internal surface of the substrate opposite to the grating at an angle which depends on the two diffraction components sin(φ_{dx}) and sin(φ_{dy}) according to the following equation:

φ_{d}=sin⁻¹{[sin²(φ_{dx})+sin²(φ_{dy})]^{1/2}} (EQ. 5)

When φ_{d} is larger than the critical angle α_{c}, the wavefront undergoes total internal reflection and begin to propagate within the substrate.

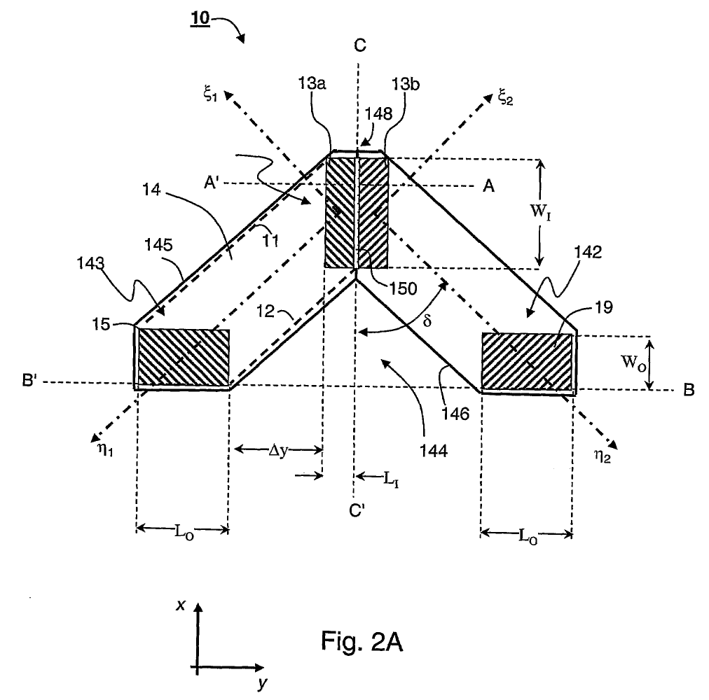

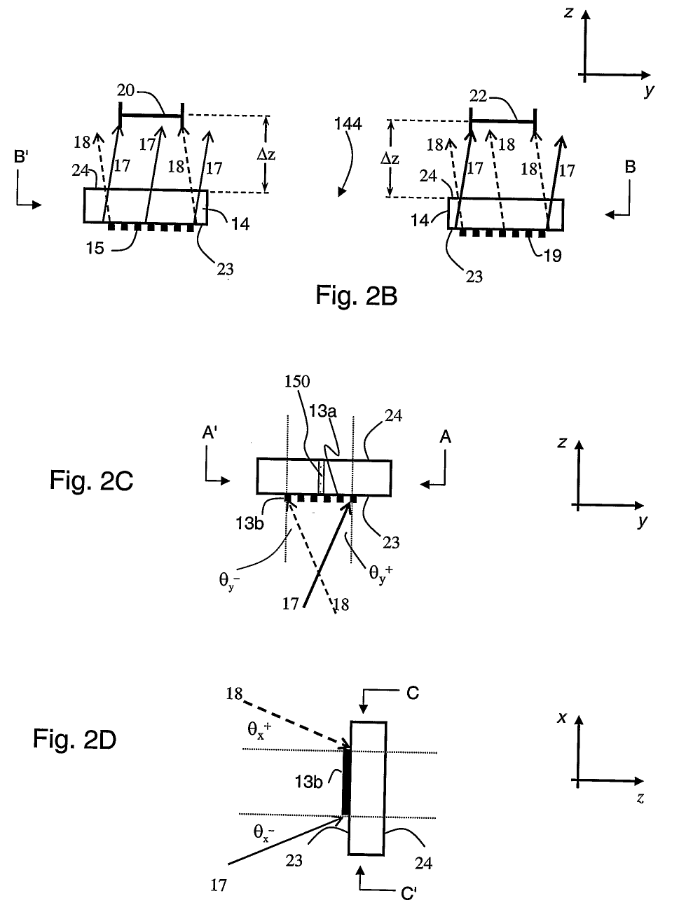

Reference is now made to FIGS. 2A-D which are schematic illustrations of a front view in the x-y plane (FIG. 2A), and cross sectional views in the y-z plane (FIGS. 2B-C) and x-z plane (FIG. 2D) of an optical relay device 10, according to various exemplary embodiments of the present invention. FIGS. 2B-D are cross sectional views along lines B-B′, A-A′ and C-C′ shown in FIG. 2A. Device 10 is particularly useful as a binocular optical device which can be held or mounted in front of the eyes of a user. The coordinate system of FIG. 2 is therefore continently selected such that the x-y plane is generally parallel to the face of the user, with the y axis being generally parallel to the line connecting the eyes of the user and the x axis being generally parallel to the symmetry axis of the user's face. The x-y plane is interchangeably referred to herein as “the vertical plane,” the x axis is interchangeably referred to herein as “the vertical axis,” and the y axis is interchangeably referred to herein as “the horizontal axis.” As will be appreciated by one of ordinary skill in the art this terminology describes a typical situation in which device 10 is held or mounted in front of the face while the user is standing or sitting. The z axis is interchangeably referred to herein as “the normal axis.”

Device 10 comprises a light-transmissive substrate 14, shaped as a structure having an apex section 141, a right section 142 and a left section 143. Substrate 14 can be made of any light transmissive material, preferably, but not obligatorily, a material having a sufficiently low birefringence.

Sections 142 and 143 are, respectively, sections of a right segment 145 and a left segment 146 which are formed as a unitary part and which define an air gap 144 separating sections 142 and 143. In the representative example of FIG. 2, the shape of substrate 14 is a chevron, in which segments 145 and 146 are straight segments extending substantially to apex section 141. However this need not necessarily be the case since the shape of substrate 14 can be a chevron-like shape with a substantially straight central segment between the two straight segments which are angled with respect to the central segment. Alternatively, the shape of substrate 14 can be a crescent, in which case segments 145 and 146 are curved, or any one of the known open plane figures with air gaps, which are traditionally referred to as V-shapes, U-shapes, C-shapes, Ω-shapes and the like.

In various exemplary embodiments of the invention device 10 comprises four optical elements generally shown at 13a, 13b, 15 and 19. Configurations with more or less optical elements are also contemplated. Elements 13a and 13b are respectively located on segments 145 and 146 at apex section 141 and serve as input optical elements which redirect the light into substrate 14 such that at least a few light rays experience total internal reflection and propagate within substrate 14. Elements 15 and 19 are respectively located at sections 143 and 142 and serve as output optical elements which redirect at least a few of the propagating light rays out of substrate 14.

Thus, device 10 receives optical input from a light source at input elements 13a and 13b and transmits optical output from output elements 15 and 19. When device 10 is held or being mounted in front of the eyes of the user, the optical output of left output element 15 is transmitted into the left eye and the optical output of right output element 19 is transmitted into the right eye. The optical input can be, for example, in the form of image data, generated by an image generating system, so as to allow the user to view a virtual image by positioning his or her eyes at a certain distance from substrate 14. A preferred lateral separation between the output elements along the horizontal axis y is from a about 30 millimeters to about 80 millimeters.

According to a preferred embodiment of the present invention device 10 further comprises an additional optical element 150 positioned at the boundary 148 between elements 13a and 13b. Element 150 serves for reducing or eliminating optical cross talks between the left side and the right side of device 10. Thus, element 150 can be a light absorber in the form of, e.g., one or more layers of light-absorbent material interposed between the input elements and configured to absorb light rays which propagate in a direction characterized by −η₁ or by −η₂. Alternatively, optical element 150 can be a light-scatterer or a light-diffuser which scatters or diffuses the light at boundary 148 so as to prevent transmission of optical information through boundary 148.

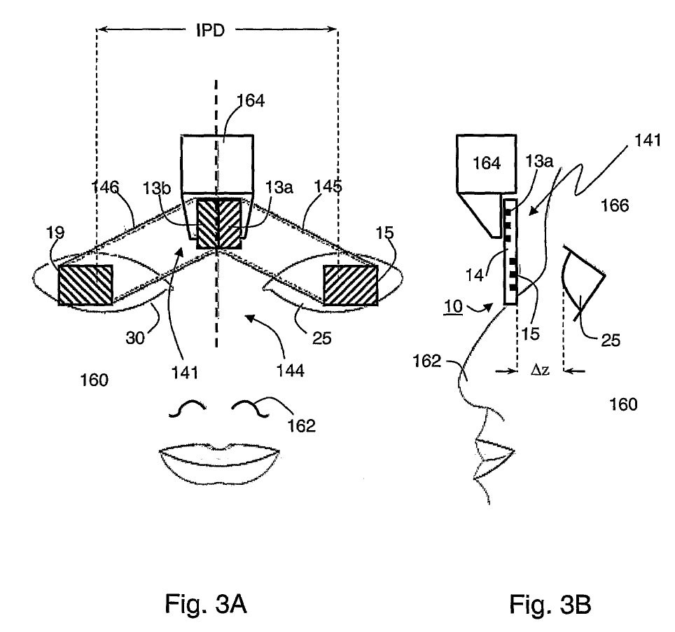

FIGS. 3A-B illustrate a schematic front view (FIG. 3a) and a schematic side view (FIG. 3b) of a preferred positioning of device 10 in front of a face 160 of a user. As shown in FIG. 3a, the left eye 25 of the user is placed in front of element 15 and the right eye 30 is of the user is placed in front of element 19. A light source 164 is in optical communication with both elements 13a and 13b, and the optical data from light source 164 is received by 13a and 13b and is transmitted through segments 145 and 146 of substrate 14 and coupled out to eyes 25 and 30 by elements 15 and 19, respectively. Air gap 144 allows the user to hold or mount device 10 close to the face by placing the nose 162 in air gap 144, such that apex section 141 is in front of the forehead 166 or upper skull.

As illustrated in FIG. 3A-B light source 164 is positioned above the line connecting elements 15 and 19. This is advantageous over conventional virtual image systems, see, e.g., U.S. patent application Ser. Nos. 10/896,865 and 11/017,920, and International Patent Application, Publication No. WO 2006/008734, where the input element is in line and between the output elements and the light source has to be mounted between the eyes of the user to maintain free optical path between the light source and the input element. In such conventional virtual image systems, the device has to be held farther from the eyes. The structure of substrate 14 in accordance with the present embodiment thus provides a compact solution to the problem of large distance between the relay device and the eyes. It is appreciated that this solution is advantageous also over other conventional virtual image systems solutions in which two synchronized light sources are used (e.g., one above each eye), because a virtual image system having two separated light sources is bulkier, heavier, more expensive and causes discomfort to the user.

The propagation of light rays via total internal reflection is generally along an axis, referred to herein as a “longitudinal axis” and denoted η. Refereeing again to FIG. 2A, two longitudinal axes are shown: a first longitudinal axis η₁ characterizes light propagation in section 145, and a second longitudinal axis η₂ characterizes light propagation in section 146. Also shown in FIG. 2A are directions perpendicular to the longitudinal axis in the vertical plane referred to herein as the “transverse axes” and denoted ξ₁ (perpendicular to η₁) and ξ₂ (perpendicular to η₂). The angle between longitudinal axes η₁ and η₂ is referred to as “the apex angle” and denoted 2δ. A preferred value for δ is between 40° and 72°, more preferably between 54° and 64°.

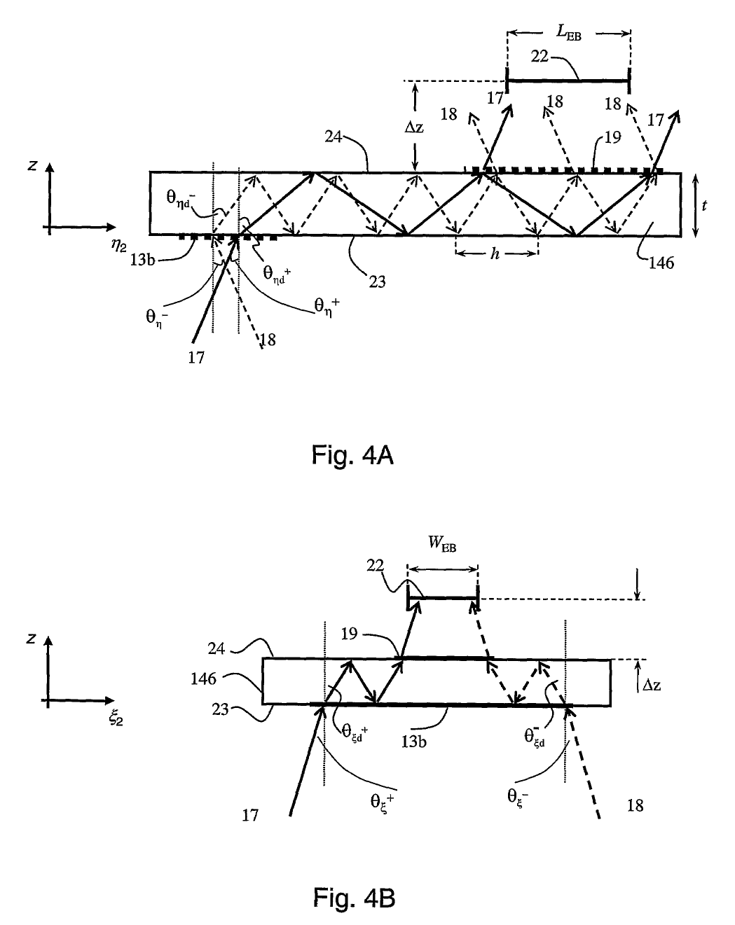

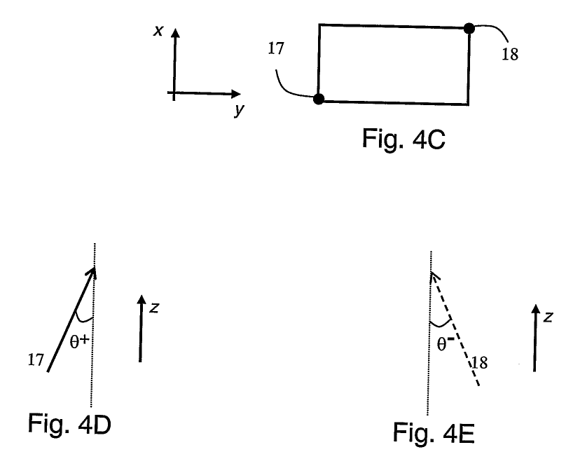

The propagation of light rays within substrate 14 can be better understood with reference FIGS. 4A-B which are fragmentary view illustrating segment 146 in a plane parallel to the η₂ and z axes (FIG. 4A), and a plane parallel to the ξ₂ and z axes (FIG. 4B). Thus, elements 13b and 19 preferably form a right input-output pair, in the sense that light redirected into the substrate by element 13b, propagates in segment 146 and being coupled out of the substrate by element 19. One ordinarily skilled in the art would know how to adjust the illustration to the propagation in segment 145. Thus, elements 13a and 15 preferably form a left input-output pair, in the sense that light redirected into the substrate by element 13a, propagates in segment 145 and being coupled out of the substrate by element 15.

Each of the optical elements can be a refractive element, a reflective element or a diffractive element. In embodiments in which a refractive element is employed, elements 13a, 13b, 15 and/or 19 can comprise a plurality of linearly stretched mini- or micro-prisms, and the redirection of light is generally by the refraction phenomenon described by Snell's law. Thus, for example, when the elements of an input-output pair are refractive elements, the input element of the pair refracts the light into substrate 14 such that at least a few light rays experience total internal reflection and propagate within substrate 14, and the output element of the pair refracts at least a few of the propagating light rays out of substrate 14. Refractive elements in the form of mini- or micro-prisms are known in the art and are found, e.g., in U.S. Pat. Nos. 5,969,869, 6,941,069 and 6,687,010, the contents of which are hereby incorporated by reference.

In embodiments in which a reflective element is employed, any of the input and/or output optical elements can comprise a plurality of dielectric mirrors, and the redirection of light is generally by the reflection phenomenon, described by the basic law of reflection. Thus, for example, when the elements of an input-output pair are reflective elements, the element of the pair reflects the light into substrate 14 such that at least a few light rays experience total internal reflection and propagate within substrate 14, and the output element of the pair reflect at least a few of the propagating light rays out of substrate 14. Reflective elements in the form of dielectric mirrors are known in the art and are found, e.g., in U.S. Pat. Nos. 6,330,388 and 6,766,082, the contents of which are hereby incorporated by reference.

Element 13a, 13b, 15 and/or 19 can also combine reflection with refraction. For example, the input and/or output optical elements can comprise a plurality of partially reflecting surfaces located in substrate 14. In this embodiment, the partially reflecting surfaces are preferably parallel to each other. Optical elements of this type are known in the art and found, e.g., in U.S. Pat. No. 6,829,095, the contents of which are hereby incorporated by reference.

In embodiments in which diffractive element is employed, the input and/or output elements can comprise a grating and the redirection of light is generally by the diffraction phenomenon. Thus, for example, when the elements of an input-output pair are diffractive elements, the input element of the pair diffracts the light into substrate 14 such that at least a few light rays experience total internal reflection and propagate within substrate 14, and the output element of the pair diffract at least a few of the propagating light rays out of substrate 14.

The term “diffracting” as used herein, refers to a change in the propagation direction of a wavefront, in either a transmission mode or a reflection mode. In a transmission mode, “diffracting” refers to change in the propagation direction of a wavefront while passing through the diffractive element; in a reflection mode, “diffracting” refers to change in the propagation direction of a wavefront while reflecting off the diffractive element in an angle different from the basic reflection angle (which is identical to the angle of incidence).

Input elements 13a and 13b are designed and constructed such that the angle of at least a few of the light rays redirected thereby is above the critical angle, to enable propagation of the light in the substrate via total internal reflection. The propagated light, after a few reflections within substrate 14, reaches one of the output elements which redirects the light out of substrate 14.

According to a preferred embodiment of the present invention at least one of the input and/or output optical elements comprises a linear diffraction grating, operating according to the principles described above. When both elements of an input-output pair are linear ratings, their periodic linear structures are preferably substantially parallel. Thus, when the left input-output pair (elements 13a and 15) is formed of linear gratings, the grating vectors of both elements 13a and 15 are parallel to longitudinal axis η₁, and the periodic linear structure of elements 13a and 15 are parallel to transverse axis ξ₁. Similarly when the right input-output pair (elements 13b and 19) is formed of linear gratings, the grating vectors of both elements 13b and 19 are parallel to longitudinal axis η₂, and the periodic linear structure of elements 13b and 19 are parallel to transverse axis ξ₂.

The optical elements can be formed on or attached to any of the surfaces 23 and 24 of substrate 14. One ordinarily skilled in the art would appreciate that this corresponds to any combination of transmissive and reflective optical elements. Thus, for example, suppose that both input optical elements are formed on surface 23 and both output optical elements are formed on surface 24. Suppose further that the light impinges on surface 23 and it is desired to diffract the light out of surface 24. In this case, the optical elements are all transmissive, so as to ensure that entrance of the light through the input optical elements, and the exit of the light through the output optical elements. Alternatively, if the input and output optical elements are all formed on surface 23, then the input optical elements remain transmissive, so as to ensure the entrance of the light therethrough, while the output optical elements are reflective, so as to reflect the propagating light at an angle which is sufficiently small to couple the light out. In such configuration, light can enter the substrate through the side opposite the input optical elements, be diffracted in reflection mode by the input optical elements, propagate within the light transmissive substrate in total internal diffraction and be diffracted out by the output optical elements operating in a transmission mode.

Optical elements 13a and 13b are preferably designed such that the larger part of light intensity carried by the incident light ray is directed towards the +η₁ and the +η₂ directions, and minimal intensity is directed towards boundary 148. For example, in the case in which elements 13a and 13b are linear diffraction gratings, the use of blazed grating design, as known in the art, can achieve such desired intensity distribution upon diffraction.

Device 10 is preferably designed to transmit light striking substrate 14 at any striking angle within a predetermined range of angles, which predetermined range of angles is referred to of the field-of-view of the device.

The input optical elements are designed to trap all light rays in the field-of-view within the substrate. A field-of-view can be expressed either inclusively, in which case its value corresponds to the difference between the minimal and maximal incident angles, or explicitly in which case the field-of-view has a form of a mathematical range or set. Thus, for example, a field-of-view, Ω, spanning from a minimal incident angle, α, to a maximal incident angle, β, is expressed inclusively as Ω=β−α, and exclusively as Ω=[α, β]. The minimal and maximal incident angles are also referred to as rightmost and leftmost incident angles or counterclockwise and clockwise field-of-view angles, in any combination. The inclusive and exclusive representations of the field-of-view are used herein interchangeably.

The field-of-view of device 10 is illustrated in FIGS. 2C-D and 4A-E by two of its outermost light rays, denoted ray 17 and ray 18 as follows.

FIGS. 2C-D and 4A-B schematically illustrate projections of rays 17 and 18 onto the y-z (FIG. 2C) x-z (FIG. 2D) planes, η-z (FIG. 4A) and ξ-z (FIG. 4B) planes, respectively. FIG. 4C schematically illustrates the field-of-view in a plane orthogonal to the normal axis (parallel to the x-y plane). Rays 17 and 18 are points on this plane. For the purpose of simplifying the presentation, the field-of-view in FIG. 4C is illustrated as a rectangle, and the straight light connecting the points is the diagonal of the rectangle. Rays 17 and 18 are referred to as the “lower-left” and “upper-right” light rays of the field-of-view, respectively.

It is appreciated that the field-of-view can also have a planar shape other than a rectangle, include, without limitation, a square, a circle and an ellipse. One of ordinary skills in the art, provided with the details described herein would know how to adjust the description for non-rectangle field-of-view. FIGS. 4D and 4E illustrate the outermost light rays in planes which are normal to the substrate and which contain rays 17 and 18.

Below, the terms “horizontal field-of-view” and “vertical field-of-view” will be used to describe the ranges of angles within the field-of-view as projected on the y-z and x-z planes respectively.

Thus, FIG. 2C schematically illustrates the horizontal field-of-view and FIG. 2D schematically illustrates the vertical field-of-view of device 10. In the horizontal field-of-view illustrated in FIG. 2C, the projection of ray 18 is the rightmost ray projection which forms with the normal axis an angle denoted θ_{y}⁻, and the projection of ray 17 is the leftmost ray projection which forms with the normal axis an angle denoted θ_{y}⁺. In the vertical field-of-view illustrated in FIG. 2D, the projection of ray 18 is the uppermost ray projection which forms with the normal axis an angle denoted θₓ⁺, and the projection of ray 17 is the lowermost ray projection which forms with the normal axis an angle denoted θₓ⁻.

In exclusive representations, the horizontal field-of-view, denoted Ω_{y}, is [θ_{y}⁻, θ_{y}⁺] and the vertical field-of-view, denoted Ωₓ is [θₓ⁻, θₓ⁺]. In the exemplified illustration of FIGS. 2C and 2D the projections θₓ⁻, θ_{y}⁻ are measured anticlockwise from the normal axis, and the projections θ⁺ₓ, θ⁺_{y} are measured clockwise from the normal axis. Thus, according to the above convention, θₓ⁻, θ_{y}⁻ have negative values and θ⁺ₓ, θ⁺_{y} have positive values, resulting in a horizontal field-of-view Ω_{y}=θ_{y}⁺+|θ_{y}⁻|, and a transverse field-of-view Ωₓ=θₓ⁺+|θₓ⁻|, in inclusive representations.

In exclusive representation, the diagonal field-of-view of device 10 is given by Ω=[θ⁻, θ⁺], where θ⁻ the angle between ray 17 and a line intersecting ray 17 and being parallel to the normal axis, and θ⁺ is the angle between ray 18 and a line intersecting ray 18 and being parallel to the normal axis. FIGS. 4D and 4E illustrate the diagonal field-of-view angles θ⁻ and θ⁺ in planes containing ray 17 and ray 18, respectively. The relation between θ^{±} and their projections θₓ^{±}, θ_{y}^{±} are given by Equation 5 above with the substitutions φ_{d}→θ^{±}, φ_{dx}→θₓ^{±} and φ_{dy}→θ_{y}^{±}. Unless specifically stated otherwise, the term “field-of-view angle” refers to a diagonal angle, such as θ^{±}.

The light rays arriving to device 10 can have one or more wavelength. When the light has a plurality of wavelengths, the shortest wavelength is denoted λ_{B} and the longest wavelength is denoted λ_{R}, and the range of wavelengths from λ_{B} to λ_{R} is referred to herein as the spectrum of the light.

Irrespectively of the number of different wavelengths of the light, when the light rays in the field-of-view impinge on elements 13a and 13b, they are preferably redirected at an angle (defined relative to the normal) which is larger than the critical angle, such that upon striking the other surface of substrate 14, all the light rays of the field-of-view experiences total internal reflection and propagate within substrate 14.

When elements 13a-b are diffractive elements, they diffract rays 17 and 18 into substrate 14 at diffraction angles denoted θ_{d}⁺ and θ_{d}⁻, respectively. Shown in FIGS. 4A-B are θ_{ηd}^{±} (FIG. 4A) and θ_{ξd}^{±} (FIG. 4B), which are the projections of θ_{d}^{±} on the η-z plane and the ξ-z plane, respectively. The relation between the incidence angles and the diffraction angles in the present Cartesian coordinate system (see also FIG. 2A) are given by Equations 2-5 with θ_{R}=π/2+δ and θ_{R}=π/2−δ for segments 145 and 146 respectively.

While propagating, the rays are reflected from the internal surfaces of substrate 14. The Euclidian distance between two successive points on the internal surface of the substrate at which a particular light ray experiences total internal reflection is referred to as the “hop length” of the light ray and denoted by “h”. The propagated light, after a few reflections within substrate 14, generally along the longitudinal axis of device 10, reaches one of the output optical elements which redirect the light out of substrate 14. Device 10 thus transmits at least a portion of the optical energy carried by each light ray between rays 17 and 18. When the light rays within the field-of-view originate from an object which emits or reflects light, a viewer can position his or her eyes in front of elements 15 and 19 to see a virtual image of the object.

As shown in FIG. 4A, for a single impingement of a light ray on the output element, only a portion of the light energy exits substrate 14. The remnant of each ray is redirected through an angle, which causes it, again, to experience total internal reflection from the other side of substrate 14. After a first reflection, the remnant may re-strike the output element, and upon each such re-strike, an additional part of the light energy exits substrate 14. Thus, a light ray propagating in the substrate via total internal reflection exits the substrate in a form of a series of parallel light rays where the distance between two adjacent light rays in the series is h. Such series of parallel light rays corresponds to a collimated light beam exiting the output elements (see rays 17 and 18 in FIG. 2B). Since more than one light ray exit as a series of parallel light rays, a beam of light passing through device 10 is expanded in a manner that the cross sectional area of the outgoing beam is larger than cross sectional area of the incoming beam.

According to a preferred embodiment of the present invention each of the output optical elements 15 and 19 is characterized by planar dimensions selected such that at least a portion of one or more outermost light rays within the field-of-view is redirected by element 15 to a two-dimensional region 20, and at least a portion of one or more outermost light rays within the field-of-view is redirected by element 19 to a two-dimensional region 22 (see FIG. 2B). More preferably, the planar dimensions of elements 15 and 19 are selected such that the light beam redirected by element 15 enters region 20 and light beam redirected by element 19 enters region 22. Preferably, but not obligatorily, the planar dimensions of region 20 equal the planar dimensions of region 22. Still preferably, both regions 20 and 22 are at the same predetermined distance Δz from light transmissive substrate 14.

The dimensions of elements 13a, 13b, 15 and 19 are schematically illustrated in FIG. 2A. In various exemplary embodiments of the invention device 10 is symmetric about the x axis (with respect to line C-C′). It these embodiments, the dimensions of elements 13a are similar to the dimensions of element 13b and the dimensions of elements 15 are similar to the dimensions of element 19.

To ensure entering of the outermost light ray or the entire outgoing light beam into regions 20 and 22, the length L_{O} of elements 15 and 19 is preferably selected to be larger then a predetermined length threshold, L_{O, min}, and the width W_{O} of elements 15 and 19 is preferably selected to be larger then a predetermined width threshold, W_{O, min}. In various exemplary embodiments of the invention the length and width thresholds are given by the following expressions:

L_{O, min}=2Δz tan(Ω_{y}/2)

W_{O, min}=2Δz tan(Ωₓ/2). (EQ. 6)

When device 10 is used for viewing a virtual image, the user may place his or her left eye within region 20 and right eye within region 22 to view the virtual image. Thus, in this embodiment, regions 20 and 22 are the “eye-box” of device 10, and Δz is approximately the distance between the pupils of the user to substrate 14 (see FIG. 3B). The distance Δz is referred to herein as the characteristic eye-relief of device 10. For transmitting an image to the eyes, the length L_{O} and width W_{O} of elements 15 and 19 are preferably approximated by L_{O}≈L_{O, min}+Oₚ, and W_{O}≈W_{O, min}+Oₚ, respectively, where Oₚ represents the diameter of the pupil and is typically about 3 millimeters. In various exemplary embodiments of the invention the eye-box is larger than the diameter of the pupil, so as to allow the user to relocate the eye within the eye-box while still viewing the entire virtual image. Thus, denoting the dimensions of regions 20 and 22 by L_{EB} and W_{EB}, where L_{EB} is measured along the y axis and W_{EB} is measured along the x axis, the length and width of elements 15 and 19 are preferably:

L_{O}=L_{O, min}+L_{EB}

W_{O}=W_{O, min}+W_{EB}, (EQ. 7)

where each of L_{EB} and W_{EB} is preferably larger than Oₚ, so as to allow the user to relocate the left eye within region 20 and the right eye within region 22 while still viewing the entire field-of-view.

The dimensions of input optical elements 13a and 13b are preferably selected to allow all light rays within the field-of-view to propagate in substrate 14 such as to impinge on the area of the respective output elements. In various exemplary embodiments of the invention each of the lengths L_{I} of input elements 13a and 13b equals from about X to about 3X, where X is preferably a unit hop-length characterizing the propagation of light rays within substrate 14 (see FIG. 4A). Typically, X equals the hop-length of the light-ray with the minimal hop-length, which is one of the outermost light-rays in the field-of-view (ray 18 in the exemplified illustration of FIG. 4A). When the light has a plurality of wavelengths, X is typically the hop-length of one of the outermost light-rays which has the shortest wavelength of the spectrum.

According to a preferred embodiment of the present invention the width W_{O} of elements 15 and 19 is smaller than the width W_{I} of elements 13a and 13b. W_{I} is preferably calculated based on the selected shape of substrate 14. According to a preferred embodiment of the present invention the relation between W_{I} and W_{O} is preferably given by the following expression:

W_{I}=W_{O}+(L_{O}+Δy) tan γ₁−(L_{I}+Δy) tan γ₂, (EQ. 8)

where Δy is the lateral separation within each input-output pair (between element 13a and element 15, and between element 13b and element 19) along the horizontal axis of device 10, and γ₁ and γ₂ are predetermined angular parameters.

Preferably, γ₁ and γ₂ relate to the propagation direction of one or more of the outermost light rays of the field-of-view within the substrate, as projected on a plane parallel to the substrate. In various exemplary embodiments of the invention γ₁ and γ₂ equal the angle formed between the horizontal axis of the substrate and the propagation direction of outermost light rays of the field-of-view, as projected on a plane parallel to the substrate. In the preferred embodiment in which substrate 14 has a structure of a chevron, γ₁ can be set to the angle formed between the horizontal axis and a straight line connecting the top left corner of element 13a with the top left corner of element 15 (or the straight line connecting the top right corner of element 13b with the to right corner of element 19), see, e.g., line 11 in FIG. 2A, and γ₂ can be the angle formed between the horizontal axis and a straight line connecting the lower right corner of element 13a with the lower right corner of element 15 (or the straight line connecting the lower left corner of element 13b with the lower left corner of element 19), see, e.g., line 12 in FIG. 2A.

Thus, a viewer placing his or her eyes in regions 20 and 22 of dimensions L_{EB}×W_{EB}, receives at least a portion of any light ray within the field-of-view, provided the distance between the eyes and the output elements equals Δz or is smaller than Δz.

The preferred value for Δz is, without limitation, from about 15 millimeters to about 35 millimeters, the preferred value for Δy is, without limitation, from a few millimeters to a few centimeters, the preferred value for L_{EB} is, without limitation, from about 5 millimeters to about 13 millimeters, and the preferred value for W_{EB} is, without limitation, is from about 4 millimeters to about 9 millimeters. For a given field-of-view, selection of large Δz results in smaller eye-box dimensions L_{EB} and W_{EB}, as known in the art. Conversely, small Δz allows for larger eye-box dimensions L_{EB} and W_{EB}.

L_{O, min} and W_{O, min} are preferably calculated using Equation 6, and together with the selected dimensions of region 20 (L_{EB} and W_{EB}), the dimensions of element 15 (L_{O} and W_{O}) can be calculated using Equation 7.

Once L_{O} and W_{O} are calculated, the width W_{I} of input element 13 is preferably calculated by means of Equation 8 with appropriate values for the predetermined parameters Δy, γ₁ and γ₂. The length of the input elements L_{I} is generally selected from about 3 millimeters to about 15 millimeters.

As can be understood from the geometrical configuration illustrated in FIGS. 4A-B, the angles at which light rays 18 and 17 are redirected can differ. As the angles of redirection depend on the incident angles (see, e.g., Equations 2-5 for the case of diffraction), the allowed clockwise (θ⁺) and anticlockwise (θ⁻) field-of-view angles, are also different. For example, the anticlockwise angle shown in FIG. 4A is limited by that angle at which the angle of redirection does not satisfy the condition for total internal reflection. Thus, device 10 supports transmission of asymmetric field-of-view in which, say, the clockwise field-of-view angle is greater than the anticlockwise field-of-view angle. The difference between the absolute values of the clockwise and anticlockwise field-of-view angles can reach more than 70% of the total field-of-view.

This asymmetry can be exploited in accordance with various exemplary embodiments of the present invention, to enlarge the field-of-view of optical device 10. According to a preferred embodiment of the present invention, the input optical elements redirect the light into substrate 14 in a manner such that different portions of the light, corresponding to different partial field-of-views, propagate within the substrate in different directions to thereby reach the output optical elements. The output optical elements redirect the different portions of the light out of the light-transmissive substrate.

In accordance with the present embodiments, the planar dimensions of the output and/or input optical elements can be selected to facilitate the transmission of the partial field-of-views. The output optical elements can also be designed and constructed such that the redirection of the different portions of the light is in complementary manner.

The terms “complementarily” or “complementary,” as used herein in conjunction with a particular observable or quantity (e.g., field-of-view, image, spectrum), refer to a combination of two or more overlapping or non-overlapping parts of the observable or quantity, which combination provides the information required for substantially reconstructing the original observable or quantity.

In various exemplary embodiments of the invention, the optical elements of the optical relay device are designed to transmit an image covering a wide field-of-view to both eyes of the user. Preferably, the optical relay device of the present embodiments is characterized by a diagonal field-of-view of at least 15° (corresponding to horizontal field-of-view of about 12°), more preferably at least 20° (corresponding to horizontal field-of-view of about 16°), more preferably at least 25° (corresponding to horizontal field-of-view of about 20°), more preferably at least 30° (corresponding to horizontal field-of-view of about 24°). The optical elements are preferably located at fixed locations on the light transmissive substrate, but provide the image for any interpupillary distance from a minimal value denoted IPDₘᵢₙ to a maximal value denoted IPDₘₐₓ.

The advantage of the present embodiments is that any user with an interpupillary distance IPD satisfying IPDₘᵢₙ≦IPD≦IPDₘₐₓ can use the device to view the entire image without having to adjust the size of the device or the separation between the optical elements. The range of IPD in western society grown-ups is from about 53 mm to about 73 mm. Children have further smaller IPD. Other human races generally have different ranges of IPD. A preferred value for IPDₘᵢₙ is from about 5 mm to about 20 millimeters less than the selected value for IPDₘₐₓ, more preferably from about 5 mm to about 10 millimeters less than the selected value for IPDₘₐₓ, and the two values are preferably selected within the range of human IPD as described above.

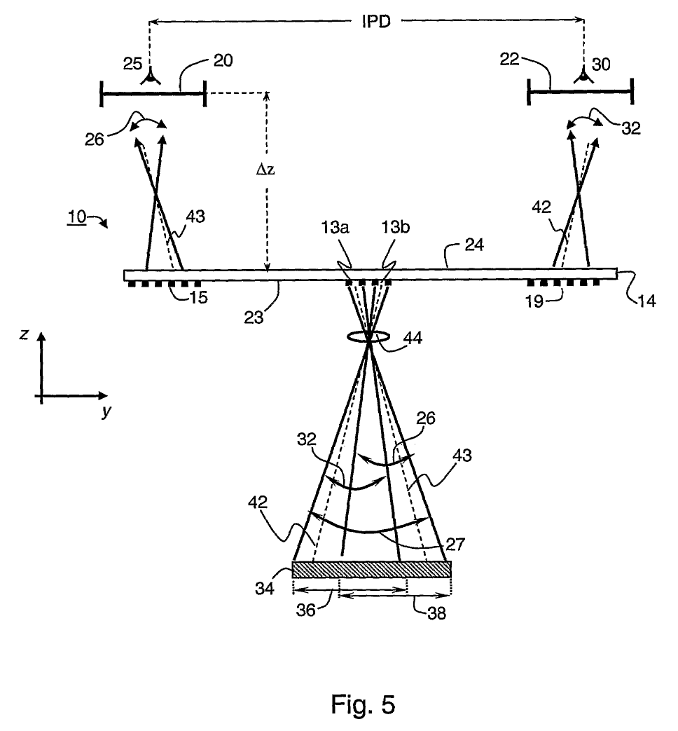

Reference is now made to FIG. 5 which is a schematic illustration of a side view of device 10 superimposing the cross sectional views along lines B-B′ and A-A′ of FIG. 2A.

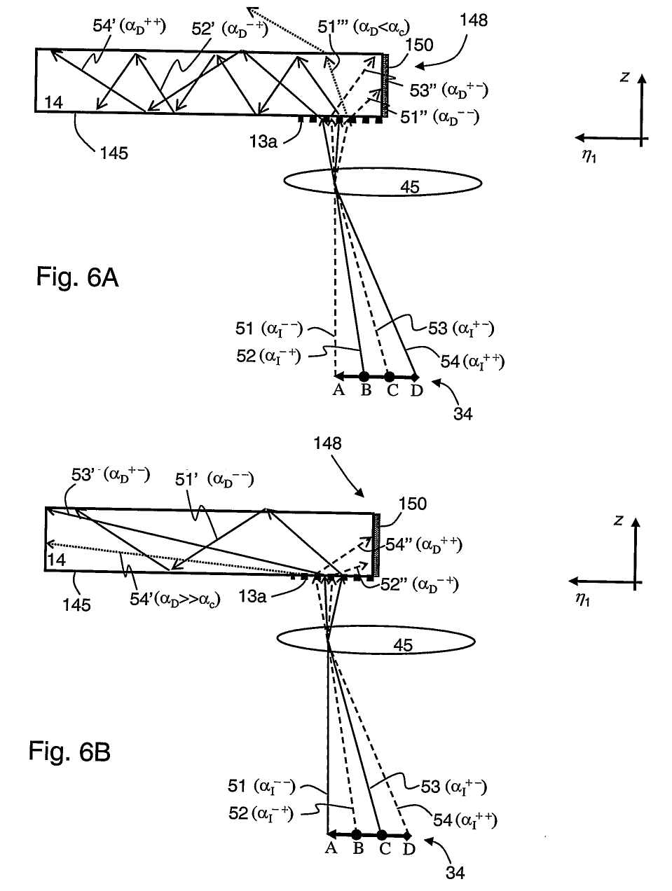

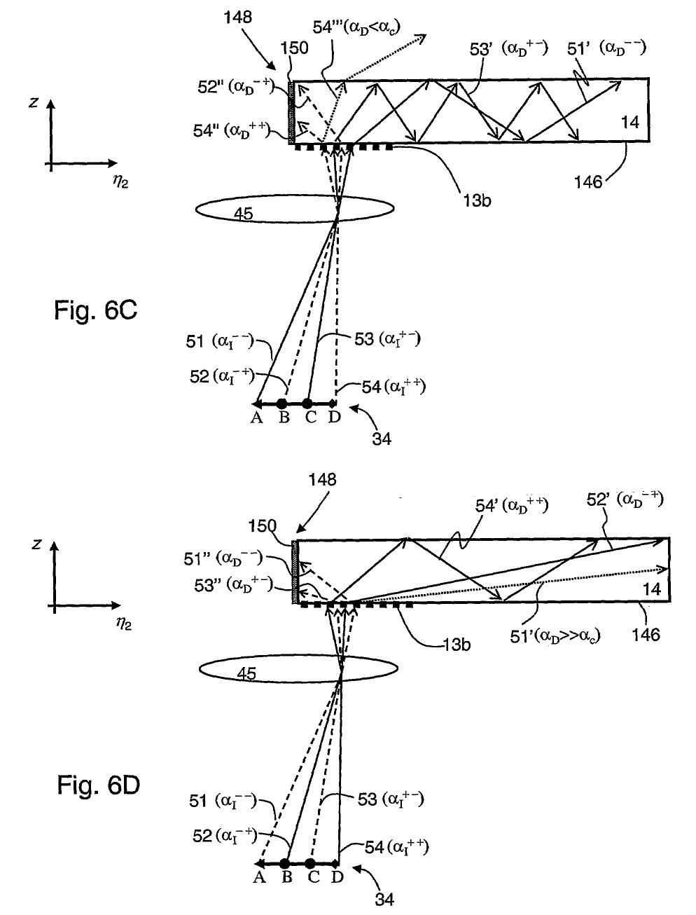

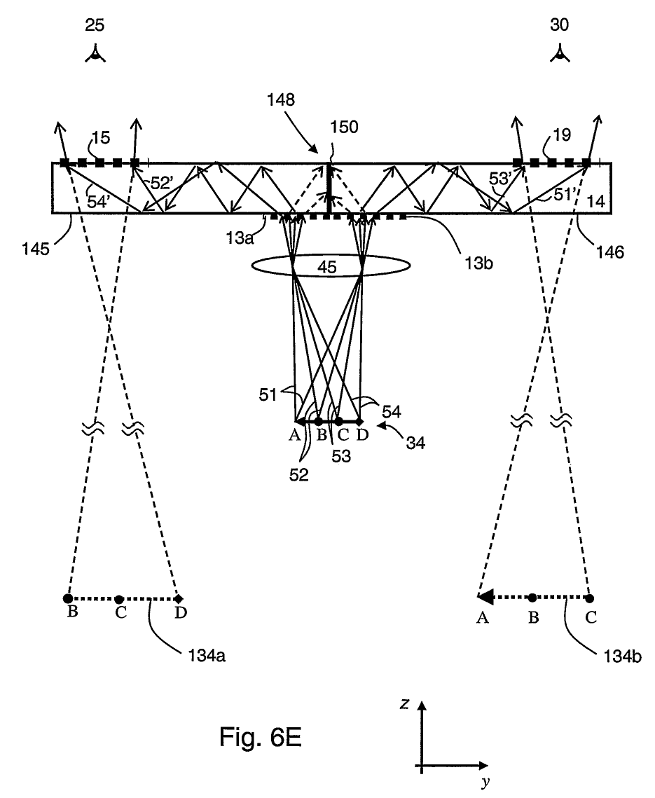

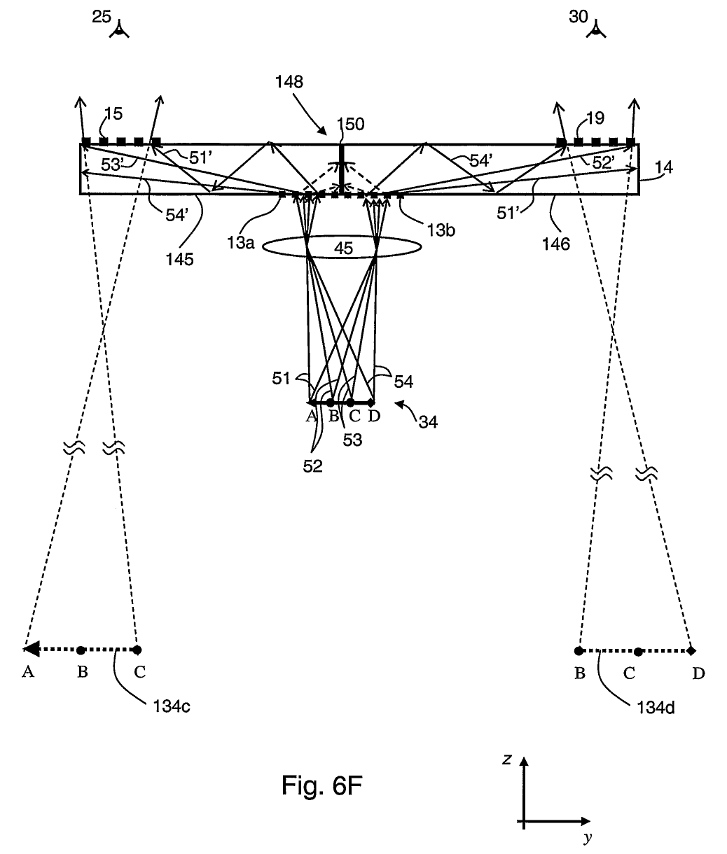

In FIG. 5, all optical elements are formed on surface 23 of substrate 14. However, as stated, this need not necessarily be the case, since, for some applications, it may be desired to form the input/output optical elements on any of the surfaces of substrate 14, in an appropriate transmissive/reflective combination. Wavefront propagation within substrate 14, according to various exemplary embodiments of the present invention, is further detailed hereinunder with reference to FIGS. 6A-B.

Elements 13a and 13b preferably redirect the incoming light into substrate 14 in a manner such that different portions of the light, corresponding to different partial fields-of-view, propagate in different directions within substrate 14. In the configuration exemplified in FIG. 5, elements 13a and 13b redirects light rays within one asymmetric partial field-of-view, designated by reference numeral 26, to impinge on element 15, and another asymmetric partial field-of-view, designated by reference numeral 32, to impinge on element 19. Elements 15 and 19 complementarily redirect the respective portions of the light, or portions thereof, out of substrate 14, to provide left eye 25 with partial field-of-view 26 and right eye 30 with partial field-of-view 32. Partial field-of-views 26 and 32 form together the field-of-view 27 of device 10.

Eyes 25 and 30, as stated, are preferably located at two-dimensional region 20 and 22 respectively. The lateral separation between the horizontal centers of regions 20 and 22 is preferably at least 40 millimeters. Preferably, the lateral separation between the horizontal centers of regions 20 and 22 is less than 80 millimeters. According to a preferred embodiment of the present invention the planar dimensions of elements 15 and 19 are selected such that the portions of outermost light rays are respectively directed to regions 20 and 22, for any lateral separation between the regions which is larger than 40 millimeters and smaller than 80 millimeters. More preferably, the planar dimensions of elements 15 and 19 are preferably selected such that eyes 25 and 30 are respectively provided with partial field-of-views 26 and 32 for any interpupillary distance IPD satisfying IPDₘᵢₙ≦IPD≦IPDₘₐₓ.

This is preferably ensured by selecting the lengths L_{EB} of regions 20 and 22 according to the following weak inequality:

L_{EB}≧(IPDₘₐₓ−IPDₘᵢₙ)/2. (EQ. 9)

Once L_{EB} is selected to satisfy Equation 9, the lengths and widths of output elements 15 and 19 can be set according to Equations 7 substantially as described hereinabove. According to a preferred embodiment of the present invention the horizontal center of each of elements 15 and 19 is located at a distance of (IPDₘₐₓ+IPDₘᵢₙ)/4 from the vertical symmetry axis of substrate 14 (line C-C′ in FIG. 2A).

When device 10 is used for transmitting an image 34, field-of-view 27 preferably includes substantially all light rays originated from image 34. Partial fields-of-view 26 and 32 can therefore correspond to different parts of image 34, which different parts are designated in FIG. 5 by numerals 36 and 38. Thus, as shown in FIG. 5, there is at least one light ray 42 which enters device 10 via element 13 and exits device 10 via element 19 but not via element 15. Similarly, there is at least one light ray 43 which enters device 10 via element 13 and exits device 10 via element 15 but not via element 19.

Generally, the partial field-of-views, hence also the parts of the image arriving to each eye depend on the wavelength of the light. Therefore, it is not intended to limit the scope of the present embodiments to a configuration in which part 36 is viewed by eye 25 and part 38 viewed by eye 30. In other words, for different wavelengths, part 36 is viewed by eye 30 and part 38 viewed by eye 25. For example, when the image is constituted by a light having three colors: red, green and blue, device 10 can be constructed such that eye 25 sees part 38 for the blue light and part 36 for the red light, while eye 30 sees part 36 for the blue light and part 38 for the red light. In such configuration, both eyes see an almost symmetric field-of-view for the green light. Thus, for every color, the two partial fields-of-view compliment each other.

The human visual system is known to possess a physiological mechanism capable of inferring a complete image based on several parts thereof, provided sufficient information reaches the retinas. This physiological mechanism operates on monochromatic as well as chromatic information received from the rod cells and cone cells of the retinas. Thus, in a cumulative nature, the two asymmetric field-of-views, reaching each individual eye, form a combined field-of-view perceived by the user, which combined field-of-view is wider than each individual asymmetric field-of-view.

According to a preferred embodiment of the present invention, there is a predetermined overlap between first 26 and second 32 partial fields-of-view, which overlap allows the user's visual system to combine parts 36 and 38 of image 34, thereby to perceive the image, as if it has been fully observed by each individual eye.

For example, the optical elements can be constructed such that the exclusive representations of partial fields-of-view 26 and 32 are, respectively, [−α, β] and [−β, α], resulting in a symmetric combined field-of-view 27 of [−β, β]. It will be appreciated that when β>>α>0, the combined field-of-view is considerably wider than each of the asymmetric field-of-views. Device 10 is capable of transmitting a field-of-view of at least 20 degrees, more preferably at least 30 degrees most preferably at least 40 degrees, in inclusive representation.

When the image is a multicolor image having a spectrum of wavelengths, different sub-spectra correspond to different, wavelength-dependent, asymmetric partial field-of-views, which, in different combinations, form different wavelength-dependent combined fields-of-view. For example, a red light can correspond to a first red asymmetric partial field-of-view, and a second red asymmetric partial field-of-view, which combine to a red combined field-of-view. Similarly, a blue light can correspond to a first blue asymmetric partial field-of-view, and a second blue asymmetric partial field-of-view, which combine to a blue combined field-of-view, and so on. Thus, a multicolor configuration is characterized by a plurality of wavelength-dependent combined field-of-views. According to a preferred embodiment of the present invention the optical elements are designed and constructed so as to maximize the overlap between two or more of the wavelength-dependent combined field-of-views.

In terms of spectral coverage, the design of device 10 is preferably as follows: element 15 provides eye 25 with, say, a first sub-spectrum which originates from part 36 of image 34, and a second sub-spectrum which originates from part 38 of image 34. Element 19 preferably provides the complementary information, so as to allow the aforementioned physiological mechanism to infer the complete spectrum of the image. Thus, element 19 preferably provides eye 30 with the first sub-spectrum originating from part 38, and the second sub-spectrum originating from part 36.

Ideally, a multicolor image is a spectrum as a function of wavelength, measured at a plurality of image elements. This ideal input, however, is rarely attainable in practical systems. Therefore, the present embodiment also addresses other forms of imagery information. A large percentage of the visible spectrum (color gamut) can be represented by mixing red, green, and blue colored light in various proportions, while different intensities provide different saturation levels. Sometimes, other colors are used in addition to red, green and blue, in order to increase the color gamut. In other cases, different combinations of colored light are used in order to represent certain partial spectral ranges within the human visible spectrum.

In a different form of color imagery, a wide-spectrum light source is used, with the imagery information provided by the use of color filters. The most common such system is using white light source with cyan, magenta and yellow filters, including a complimentary black filter. The use of these filters could provide representation of spectral range or color gamut similar to the one that uses red, green and blue light sources, while saturation levels are attained through the use of different optical absorptive thickness for these filters, providing the well known “grey levels.”

Thus, the multicolored image can be displayed by three or more channels, such as, but not limited to, Red-Green-Blue (RGB) or Cyan-Magenta-Yellow-Black (CMYK) channels. RGB channels are typically used for active display systems (e.g., CRT or OLED) or light shutter systems (e.g., Digital Light Processing™ (DLP™) or LCD illuminated with RGB light sources such as LEDs). CMYK images are typically used for passive display systems (e.g., print). Other forms are also contemplated within the scope of the present invention.

When the multicolor image is formed from a discrete number of colors (e.g., an RGB display), the sub-spectra can be discrete values of wavelength. For example, a multicolor image can be provided by an OLED array having red, green and blue organic diodes (or white diodes used with red, green and blue filters) which are viewed by the eye as continues spectrum of colors due to many different combinations of relative proportions of intensities between the wavelengths of light emitted thereby. For such images, the first and the second sub-spectra can correspond to the wavelengths emitted by two of the blue, green and red diodes of the OLED array, for example the blue and red. Device 10 can be constructed such that, say, eye 30 is provided with blue light from part 36 and red light from part 38 whereas eye 25 is provided with red light from part 36 and blue light from part 38, such that the entire spectral range of the image is transmitted into the two eyes and the physiological mechanism reconstructs the image.

The light arriving at the input optical element of device 10 is preferably collimated. In case the light is not collimated, a collimator 44 can be positioned on the light path between image 34 and the input element.

Collimator 44 can be, for example, a converging lens (spherical or non spherical), an arrangement of lenses and the like. Collimator 44 can also be a diffractive optical element, which may be spaced apart, carried by or formed in substrate 14. A diffractive collimator may be positioned either on the entry surface of substrate 14, as a transmissive diffractive element or on the opposite surface as a reflective diffractive element.

Reference is now made to FIGS. 6A-D which illustrate wavefront propagation within segments 145 (FIGS. 6A-B) and 146 (FIGS. 6C-D), in the preferred embodiments in which different partial field-of-views propagate within in different segments of the light transmissive substrate. FIGS. 6A-D are schematic fragmentary views of device 10 in planes which are parallel to the η₁-z (FIGS. 6A-B), and η₂-z (FIG. 6C-D) planes. Reference is conjointly made also to FIGS. 6E-F which are schematic illustrations in which the cross sectional views of device 10 along lines B-B′ and A-A′ are superimposed.

Four families of light rays are shown in FIGS. 6A-F, each shown family represents light rays which are emitted from a different point of image 34. Specifically, light rays families designated by reference numerals 51, 52, 53 and 54 represent light rays which are emitted from points of image 34 designated by reference numerals A, B, C and D, respectively. The projections of the incident angles of rays 51, 52, 53 and 54 onto the η₁-z or η₂-z plane relative to the normal axis are denoted α₁⁻⁻, α₁⁻⁺, α₁⁺⁻ and α₁⁺⁺, respectively.

According to the common conventions, the incident angles are measured with respect to the normal to the substrate (the z axis in the present Cartesian coordinate system) at the point of entry to the substrate. As stated, the light entering device 10 is preferably collimated. In the representative example illustrated in FIGS. 6A-F, a lens 45 is used for collimating the light. In this example, each light ray belonging to a particular family of light rays, is emitted by the respective point of image 34 at a different direction. Once collimated by lens 45, all light rays of the family impinge on the surface of the substrate substantially at the same incident angle. Alternatively, the light can be provided by an image generating system which emits a collimated light. In this embodiment, all light rays which constitute imagery information of a particular point of the image are parallel.

Thus, in any event, all light rays of family 51 impinge on substrate 14 at the same angle, which has a projection α₁⁻⁻ on the η-z planes; all light rays of family 52 impinge on substrate 14 at the same angle, which has a projection α₁⁻⁺ on the η-z planes; all light rays of family 53 impinge on substrate 14 at the same angle, which has a projection α₁⁺⁻ on the η-z planes; and all light rays of family 54 impinge on substrate 14 at the same angle, which has a projection α₁⁺⁺ on the η-z planes.

As will be appreciated by one of ordinary skill in the art, the first superscript index refer to the position of the respective ray relative to the center of the field-of-view, and the second superscript index refer to the position of the respective ray relative to the normal from which the angle is measured, according to the aforementioned sign convention.

It is to be understood that this sign convention cannot be considered as limiting, and that one ordinarily skilled in the art can easily practice the present invention employing an alternative convention.

Similar notations will be used below for diffraction angles of the rays, with the subscript D replacing the subscript I. Denoting the superscript indices by a pair i,j, an incident angle is denoted generally as α₁^{ij}, and a projection of a diffraction angle onto the η₁-z or η₂-z plane is denoted generally as α_{D}^{ij}, where ij=“−−”, “−+”, “+−” or “−−”. The relation between each incident angle, α₁^{ij}, and its respective diffraction angle, α_{D}^{ij}, is given by Equations 2-3, above, with θ_{R}=π/2+δ and θ_{R}=π/2−δ for segments 145 and 146 respectively.

Points A and D represent the left end and the right end of image 34, and points B and C are located between points A and D. Thus, rays 51 and 53 are the leftmost and the rightmost light rays of a first asymmetric field-of-view, corresponding to a part A-C of image 34, and rays 52 and 54 are the leftmost and the rightmost light rays of a second asymmetric field-of-view corresponding to a part B-D of image 34. In angular notation, the first and second asymmetric field-of-views are, respectively, [α₁⁻⁻, α₁⁺⁻] and [α₁⁻⁺, α₁⁺⁺] (exclusive representations). Note that an overlap field-of-view between the two asymmetric field-of-views is defined between rays 52 and 53, which overlap equals [α₁⁻⁺, α₁⁺⁻] and corresponds to an overlap B-C between parts A-C and B-D of image 34.

In the configuration shown in FIGS. 6A-D, a lens 45 magnifies image 34 and collimates the wavefronts emanating therefrom. Image 34 preferably lies in the focal plane of lens 45 thereby ensuring that light rays originated from each point of the image impinge on both elements 13a and 13b as a plurality of parallel light rays. For example, light rays 51-54 pass through lens 45, impinge on both input optical elements 13a and 13b at angles α₁^{ij} and diffracted thereby into substrate 14 at angles α_{D}^{ij}.

For the purpose of clarity of presentation, each light ray emitted from image 34 is labeled in FIGS. 6A-D according to the incident angle (α₁⁻⁻, α₁⁻⁺, α₁⁺⁻ or α₁⁺⁺) which characterizes its propagation direction upon impingement on the surface of substrate 14. In the present representative example in which the light is collimated by lens 45, the incident angles characterize the propagation direction of the light rays after being collimated. As will be appreciated by one of ordinary skill in the art, since the lens redirects all but principles light rays passing therethrough, the incident angles α₁⁻⁻, α₁⁻⁺, α₁⁺⁻ and α₁⁺⁺ typically differ from the angles at which the light rays are emitted from image 34. When an image source which provides collimated light is employed, the incident angles can characterize the propagation direction of the light rays as emitted by the image source.

The diffracted light rays are labeled in FIGS. 6A-D by their respective diffraction angles (α_{D}⁻⁻, α_{D}⁻⁺, α_{D}⁺⁻, α_{D}⁺⁺) which are related to the incident angles through Equations 2-3, with the appropriate value for θ_{R}, as described hereinabove.

Each diffracted light ray experiences a total internal reflection upon impinging on the inner surfaces of substrate 14 provided that |α_{D}^{ij}|, the absolute value of the diffraction angle, is larger than the critical angle α_{c}. Light rays with |α_{D}^{ij}<α_{c} do not experience a total internal reflection hence escape from substrate 14.

A light ray impinging on a particular input element having a grating vector η is diffracted both along η and along −η, corresponding to diffraction orders +1 and −1, respectively. Higher diffraction orders may also exist, but are typically suppressed. Consider, for example, a situation in which a light ray impinges on left input element 13a (FIGS. 6A-B) and being diffracted at a diffraction angle satisfying |α_{D}^{ij|>α}_{c}. Two secondary light rays are thus formed. The secondary light ray that corresponds to diffraction order +1, propagates via total internal reflection within segment 145 generally along the direction +η₁. The secondary light ray that corresponds to diffraction order −1, impinges on the boundary 148 between elements 13a and 13b. As stated, optical elements 13a and 13b are preferably designed such that the larger part of light intensity carried by the incident light ray is directed towards the +θ₁ and the +η₂ directions, and minimal intensity is directed towards boundary 148. In this embodiment, the secondary light rays that corresponds to diffraction order −1 have minimal or no effect on wavefront propagation in the other segment of device 10. Alternatively or additionally, element 150 can be positioned at boundary 148, in which case cross talks between the input elements is prevented or reduced, via absorption, scattering and/or diffusion of light rays. Similarly, a light ray which impinges on right input element 13b (FIGS. 6C-D) and which is diffracted at a diffraction angle satisfying |α_{D}^{ij}|>α_{c}, is also split into two secondary light rays. The secondary light ray that corresponds to diffraction order +1, propagates via total internal reflection within segment 146 generally along the direction +η₂, and the secondary light ray that corresponds to diffraction order −1, impinges on boundary 148 and optionally element 150 as explained above.

On the other hand, no propagation via total internal reflection takes place for diffraction angles which are smaller than α_{c}. Thus, a light ray splits into two secondary light rays such that diffraction order +1 is at an angle which is smaller than α_{c}, does not propagate via total internal reflection because the +1 diffraction order escapes from the substrate and the −1 diffraction order is absorbed by boundary 148.

To ease the understanding of the illustrations in FIGS. 6A-B, secondary rays which are diffracted to propagate in the respective segment via total internal reflection are designated by a single prime (′) and secondary rays which are absorbed in boundary 148 are designated by a double prime (″). Secondary rays which do not satisfy the total internal reflection condition are designated by a triple prime (′″).

Reference is now made to FIG. 6A showing segment 145 in a preferred embodiment of in which |α_{D}⁻⁺|=|α_{D}⁺⁻|=α_{c}. Shown in FIG. 6A are rays 52′ and 54′ which propagate in segment 145 and rays 51″ and 53″ which are absorbed by boundary 148. Also shown is ray 51′″, which does not undergo total internal reflection, and exits substrate 14 upon reaching surface 24. A complementary situation is illustrated in FIG. 6C, for segment 146. As shown, rays 51′ and 53′ propagate in segment 146, and rays 52″ and 54″ are absorbed by boundary 148, and ray 54′″ exits substrate 14. Thus, all light rays between rays 52 and 54 propagate within segment 145, while all light rays between rays 51 and 53 propagate within segment 146. On the other hand, the light rays between rays 53 and 54 propagate within segment 145 but not within segment 146, while the light rays between rays 51 and 52 propagate within segment 146 but not within segment 145. The light rays corresponding to the overlap between the asymmetric field-of-views (between rays 52 and 53), propagate in both segments.

Thus, FIGS. 6A and 6C depict a preferred embodiment in which light rays of the asymmetrical field-of-view defined between rays 51 and 53 reach second output optical element 19 (not shown in FIGS. 6A and 6C), and light rays of the asymmetrical field-of-view defined between rays 52 and 54 reach first output optical element 15 (not shown in FIGS. 6A and 6C).

In another preferred embodiment, illustrated in FIGS. 6B and 6D, the light rays at the largest entry angle are diffracted at diffraction angles which are larger than α_{c}, hence do not escape from substrate 14. However, whereas some secondary rays experience a few reflections within substrate 14, and thus successfully reach its respective output optical element, the diffraction angle of other secondary rays is too large for the secondary rays to impinge the other side of substrate 14. Such light secondary rays do not properly propagate via total internal reflection and do not reach the output elements.

Specifically shown in FIG. 6B are original rays 51, 52, 53 and 54 and secondary rays 51′, 52″, 53′, 54′ and 54″: rays 52″ and 54″ are absorbed by boundary 148; rays 51′ and 53′ propagate in segment 145 via total internal reflection to impinge on element 15; and ray 54′ either diffracts at an angle α_{D}>>α_{c} which is too large to successfully reach element 15, or evanesces. A complementary situation is illustrated in FIG. 6D, for segment 146: rays 51″ and 53″ are absorbed by boundary 148; rays 52′ and 54′ propagate in segment 146 via total internal reflection to impinge on element 19; and ray 51′ either diffracts at an angle α_{D}>>α_{c} which is too large to successfully reach element 19, or evanesces.

According to the presently preferred embodiment of the invention, input element 13a is designed and constructed such that α_{D}⁺⁻ (the diffraction angle of ray 53′ in FIG. 6B) is the largest angle for which a diffracted light ray successfully reaches output element 15, and α_{D}⁻⁺ (the diffraction angle of ray 52′ in FIG. 6D) is the largest angle for which a diffracted light ray successfully reaches output element 19. Thus, FIGS. 6B and 6D depict a preferred embodiment in which light rays of the asymmetrical field-of-view defined between rays 51 and 53 reach output optical element 15, and light rays of the asymmetrical field-of-view defined between rays 52 and 54 reach output optical element 15.

It is appreciated that although the wave propagation scenarios are described above in the context of two separate embodiments, they may also be provided in combination in a single embodiment. Specifically, since the relation between the incident and diffraction angles depends on the wavelength of the light, one wave propagation scenario can be realized for one sub-spectrum while the other scenario can be realized for another sub-spectrum. For example, the scenario described in the context of FIGS. 6A and 6C can be realized for wavelengths in the green-to-blue part of the visible spectrum while the context of FIGS. 6B and 6D can be realized for the red-to-green part of the visible spectrum. Thus, the left input-output pair (elements 13a and 15) transmits via segment 145 green-to-blue light rays from part B-D of image 34, and red-to-green light rays from part A-C of image 34. Similarly, the right input-output pair (elements 13b and 19) transmits via segment 146 red-to-green light rays from part B-D of image 34, and green-to-blue light rays from part A-C of image 34.

FIGS. 6E-F are schematic illustrations in which the cross sectional views of device 10 along lines B-B′ and A-A′ are superimposed to show light propagation in both segments 145 and 146. Also shown in FIGS. 6E-F are virtual images 134a and 134c as viewed by the left eye 25, and virtual images 134b and 134d as viewed by the right eye 30. As will be appreciated by one of ordinary skill in the art, virtual images 134a-d are not projected onto or emitted from a viewing surface, because the light rays which constitute image 34 are collimated upon entering and exiting device 10. Thus, there are no real light rays which connect virtual images 134a-d and the eyes. Each eye, thus perceives a virtual image which is typically located at infinity, and, in any event, farther from the eye than original image 34. Virtual images 134a-d are therefore enlarged with respect to the original image.

The illustration of FIG. 6E is particularly applicable to the shorter wavelengths of the spectrum (say from green to blue), where element 15 transmits a (virtual) image 134a consisting of part B-D of image 34, while element 19 transmits a (virtual) image 134b consisting of part A-C of image 34. The illustration of FIG. 6F is particularly applicable to the longer wavelengths of the spectrum (say from red to green), where element 19 transmits a virtual image 134d consisting of part B-D, while element 15 transmits a virtual image 134c consisting of part A-C of image 34. Any of the above embodiments can be successfully implemented by a judicious design of the input/output optical elements and the substrate.

For example, as stated, the input and output optical elements can be linear diffraction gratings in which members of the same input-output pair has identical periods and being in a parallel orientation. This embodiment is advantageous because it is angle-preserving. Specifically, the identical periods and parallelism of the linear gratings ensure that the relative orientation between light rays exiting the substrate is similar to their relative orientation before the impingement on the input optical element. Consequently, light rays emanating from a particular point of the overlap part B-C of image 34, hence reaching both eyes, are parallel to each other. Thus, such light rays can be viewed by both eyes as arriving from the same angle in space. It will be appreciated that with such configuration viewing convergence is easily obtained without eye-strain or any other inconvenience to the viewer, unlike the prior art binocular devices in which relative positioning and/or relative alignment of the optical elements is necessary.

In a preferred embodiment in which surfaces 23 and 24 of substrate 14 are substantially parallel, the optical elements can be designed, for a given spectrum, solely based on the value of θ⁻ and the value of the shortest wavelength λ_{B}. For example, when the optical elements are linear gratings, the period, D, of the gratings can be selected based on θ⁻ and λ_{B}, irrespectively of the optical properties of substrate 14 or any wavelength longer than λ_{B}.

According to a preferred embodiment of the present invention D is selected such that the ratio λ_{B}/D is from about 1 to about 2. A preferred expression for D is given by the following equation:

D=λ_{B}/[n_{A}(1−sin θ⁻)]. (EQ. 10)

It is appreciated that D, as given by Equation 10, is a maximal grating period. Hence, in order to accomplish total internal reflection D can also be smaller than λ_{B}/[n_{A}(1−sin θ⁻)].

Substrate 14 is preferably selected such as to allow light having any wavelength within the spectrum and any striking angle within the field-of-view to propagate in substrate 14 via total internal reflection.

According to a preferred embodiment of the present invention the refraction index of substrate 14 is larger than λ_{R}/D+n_{A} sin(θ⁺). More preferably, the refraction index, n_{S}, of substrate 14 satisfies the following equation:

n_{S}≧[λ_{R}/D+n_{A} sin(θ⁺)]/sin(α_{D}^{MAX}). (EQ. 11)

where α_{D}^{MAX} is the largest diffraction angle, e.g., the diffraction angle of the light ray 17. There are no theoretical limitations on α_{D}^{MAX}, except from a requirement that it is positive and smaller than 90 degrees. α_{D}^{MAX} can therefore have any positive value smaller than 90°. Various considerations for the value α_{D}^{MAX} are found in U.S. Pat. No. 6,757,105, the contents of which are hereby incorporated by reference.

The thickness, t, of substrate 14 is preferably from about 0.1 mm to about 5 mm, more preferably from about 1 mm to about 3 mm, even more preferably from about 1 to about 2.5 mm. For multicolor use, t is preferably selected to allow simultaneous propagation of plurality of wavelengths, e.g., t>10 λ_{R}. The length of each of segments 145 and 146 of substrate 14 is preferably from about 10 mm to about 100 mm. Device 10 is capable of transmitting light having a spectrum spanning over at least 100 nm. More specifically, the shortest wavelength, λ_{B}, generally corresponds to a blue light having a typical wavelength of between about 400 to about 500 nm and the longest wavelength, λ_{R}, generally corresponds to a red light having a typical wavelength of between about 600 to about 700 nm.

According to a preferred embodiment of the present invention the period, D, of the gratings and/or the refraction index, n_{S}, of the substrate can be selected so to provide the two asymmetrical field-of-views, while ensuring a predetermined overlap therebetween. This can be achieved in more than one way.

Hence, in one embodiment, a ratio between the wavelength, λ, of the light and the period D is larger than or equal a unity:

λ/D≧1. (EQ. 12)

This embodiment can be used to provide an optical device operating according to the aforementioned principle in which there is no mixing between light rays of the non-overlapping parts of the field-of-view (see FIG. 6A).

In another embodiment, the ratio λ/D is smaller than the refraction index, n_{S}, of the substrate. More specifically, D and n_{S} can be selected to comply with the following inequality:

D>λ/(n_{S}p), (EQ. 13)

where p is a predetermined parameter which is smaller than 1.

The value of p is preferably selected so as to ensure operation of the device according to the principle in which some mixing is allowed between light rays of the non-overlapping parts of the field-of-view, as further detailed hereinabove (see FIG. 6B). This can be done for example, by setting p=sin(α_{D}^{MAX}), where (α_{D}^{MAX}) is a maximal diffraction angle. Because there are generally no theoretical limitations on α_{D}^{MAX} (apart from a requirement that its absolute value is smaller than 90°), it may be selected according to any practical considerations, such as cost, availability or geometrical limitations which may be imposed by a certain miniaturization necessity. Hence, in one embodiment, further referred to herein as the “at least one hop” embodiment, α_{D}^{MAX} is selected so as to allow at least one reflection within a predetermined distance x which may vary from about 30 mm to about 80 mm.

For example, for a glass substrate, with an index of refraction of n_{S}=1.5 and a thickness of 2 mm, a single total internal reflection event of a light having a wavelength of 465 nm within a distance x of 34 mm, corresponds to α_{D}^{MAX}=83.3°.

In another embodiment, further referred to herein as the “flat” embodiment, α_{D}^{MAX} is selected so as to reduce the number of reflection events within the substrate, e.g., by imposing a requirement that all the diffraction angles will be sufficiently small, say, below 80°.

In an additional embodiment, particularly applicable to those situations in the industry in which the refraction index of the substrate is already known (for example when device 10 is intended to operate synchronically with a given device which includes a specific substrate), Equation 13 may be inverted to obtain the value of p hence also the value of α_{D}^{MAX}=sin⁻¹p.

As stated, device 10 can transmit light having a plurality of wavelengths. According to a preferred embodiment of the present invention, for a multicolor image the gratings period is preferably selected to comply with Equation 12, for the shortest wavelength, and with Equation 13, for the longest wavelength. Specifically:

λ_{R}/(n_{S}p)≦D≦λ_{B,} (EQ. 14)

where λ_{B} and λ_{R} are, respectively, the shortest and longest wavelengths of the multicolor spectrum. Note that it follows from Equation 12 that the index of refraction of the substrate should satisfy, under these conditions, n_{S}p≧λ_{R}/λ_{B}.

The grating period can also be smaller than the sum λ_{B}+λ_{R}, for example:

$$D = \frac{{λ}_{B} + {λ}_{R}}{{n}_{S} sin ( {α}_{D}^{MAX} ) + {n}_{A}} . \qquad ( EQ . 15 )$$

According to an additional aspect of the present invention there is provided a system 100 for providing an image to a user in a wide field-of-view.

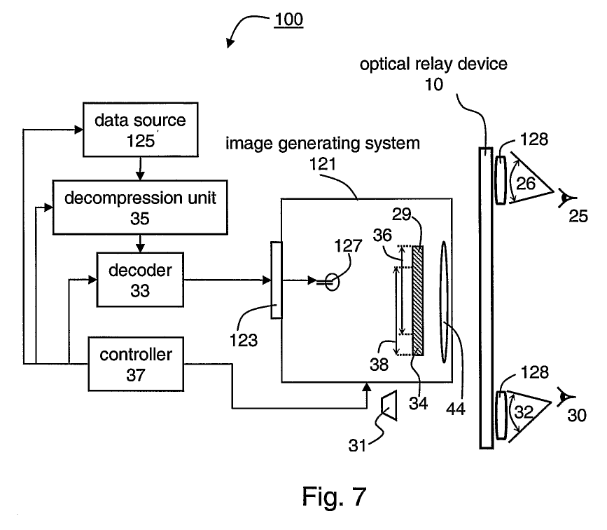

Reference is now made to FIG. 7 which is a schematic illustration of system 100, which, in its simplest configuration, comprises optical relay device 10 for transmitting image 34 into first eye 25 and second eye 30 of the user, and an image generating system 121 for providing optical relay device 10 with collimated light constituting the image.

Image generating system 121 can be either analog or digital. An analog image generating system typically comprises a light source 127, at least one image carrier 29 and a collimator 44. Collimator 44 serves for collimating the input light, if it is not already collimated, prior to impinging on substrate 14. In the schematic illustration of FIG. 7, collimator 44 is illustrated as integrated within system 121, however, this need not necessarily be the case since, for some applications, it may be desired to have collimator 44 as a separate element. Thus, system 121 can be formed of two or more separate units. For example, one unit can comprise the light source and the image carrier, and the other unit can comprise the collimator. Collimator 44 is positioned on the light path between the image carrier and the input element of device 10.

Any collimating element known in the art may be used as collimator 44, for example a converging lens (spherical or non spherical), an arrangement of lenses, a diffractive optical element and the like. The purpose of the collimating procedure is for improving the imaging ability.

In case of a converging lens, a light ray going through a typical converging lens that is normal to the lens and passes through its center, defines the optical axis. The bundle of rays passing through the lens cluster about this axis and may be well imaged by the lens, for example, if the source of the light is located as the focal plane of the lens, the image constituted by the light is projected to infinity.

Other collimating means, e.g., a diffractive optical element, may also provide imaging functionality, although for such means the optical axis is not well defined. The advantage of a converging lens is due to its symmetry about the optical axis, whereas the advantage of a diffractive optical element is due to its compactness.

Representative examples for light source 127 include, without limitation, a lamp (incandescent or fluorescent), one or more LEDs or OLEDs, and the like. Representative examples for image carrier 29 include, without limitation, a miniature slide, a reflective or transparent microfilm and a hologram. The light source can be positioned either in front of the image carrier (to allow reflection of light therefrom) or behind the image carrier (to allow transmission of light therethrough). Optionally and preferably, system 121 comprises a miniature CRT. Miniature CRTs are known in the art and are commercially available, for example, from Kaiser Electronics, a Rockwell Collins business, of San Jose, Calif.

A digital image generating system typically comprises at least one display and a collimator. The use of certain displays may require, in addition, the use of a light source. In the embodiments in which system 121 is formed of two or more separate units, one unit can comprise the display and light source, and the other unit can comprise the collimator.

Light sources suitable for a digital image generating system include, without limitation, a lamp (incandescent or fluorescent), one or more LEDs (e.g., red, green and blue LEDs) or OLEDs, and the like. Suitable displays include, without limitation, rear-illuminated transmissive or front-illuminated reflective LCD, OLED arrays, Digital Light Processing™ (DLP™) units, miniature plasma display, and the like. A positive display, such as OLED or miniature plasma display, may not require the use of additional light source for illumination. Transparent miniature LCDs are commercially available, for example, from Kopin Corporation, Taunton, Mass. Reflective LCDs are commercially available, for example, from Brillian Corporation, Tempe, Ariz. Miniature OLED arrays are commercially available, for example, from eMagin Corporation, Hopewell Junction, N.Y. DLP™ units are commercially available, for example, from Texas Instruments DLP™ Products, Plano, Tex. The pixel resolution of the digital miniature displays varies from QVGA (320×240 pixels) or smaller, to WQUXGA (3840×2400 pixels).

According to a preferred embodiment of the present invention system 100 comprises a data source 125 which can communicate with system 121 via a data source interface 123. Any type of communication can be established between interface 123 and data source 125, including, without limitation, wired communication, wireless communication, optical communication or any combination thereof. Interface 123 is preferably configured to receive a stream of imagery data (e.g., video, graphics, etc.) from data source 125 and to input the data into system 121. Many types or data sources are contemplated. According to a preferred embodiment of the present invention data source 125 is a communication device, such as, but not limited to, a cellular telephone, a personal digital assistant and a portable computer (laptop). Additional examples for data source 125 include, without limitation, television apparatus, portable television device, satellite receiver, video cassette recorder, digital versatile disc (DVD) player, digital moving picture player (e.g., MP4 player), digital camera, video graphic array (VGA) card, and many medical imaging apparatus, e.g., ultrasound imaging apparatus, digital X-ray apparatus (e.g., for computed tomography) and magnetic resonance imaging apparatus.

In addition to the imagery information, data source 125 may generates also audio information. The audio information can be received by interface 123 and provided to the user, using an audio unit 31 (speaker, one or more earphones, etc.).

According to various exemplary embodiments of the present invention, data source 125 provides the stream of data in an encoded and/or compressed form. In these embodiments, system 100 further comprises a decoder 33 and/or a decompression unit 35 for decoding and/or decompressing the stream of data to a format which can be recognized by system 121. Decoder 33 and decompression unit 35 can be supplied as two separate units or an integrated unit as desired.

System 100 preferably comprises a controller 37 for controlling the functionality of system 121 and, optionally and preferably, the information transfer between data source 125 and system 121. Controller 37 can control any of the display characteristics of system 121, such as, but not limited to, brightness, hue, contrast, pixel resolution and the like. Additionally, controller 37 can transmit signals to data source 125 for controlling its operation. More specifically, controller 37 can activate, deactivate and select the operation mode of data source 125. For example, when data source 125 is a television apparatus or being in communication with a broadcasting station, controller 37 can select the displayed channel; when data source 125 is a DVD or MP4 player, controller 37 can select the track from which the stream of data is read; when audio information is transmitted, controller 37 can control the volume of audio unit 31 and/or data source 125.

System 100 or a portion thereof (e.g., device 10) can be integrated with a wearable device, such as, but not limited to, a helmet or spectacles, to allow the user to view the image, preferably without having to hold optical relay device 10 by hand.

Device 10 can also be used in combination with a vision correction device 128, for example, one or more corrective lenses for correcting, e.g., short-sightedness (myopia). In this embodiment, the vision correction device is preferably positioned between the eyes and device 10. According to a preferred embodiment of the present invention system 100 further comprises correction device 128, integrated with or mounted on device 10.

The present embodiments can also be provided as add-ons to the data source or any other device capable of transmitting imagery data. Additionally, the present embodiments can also be used as a kit which includes the data source, the image generating system, the binocular device and optionally the wearable device. For example, when the data source is a communication device, the present embodiments can be used as a communication kit.

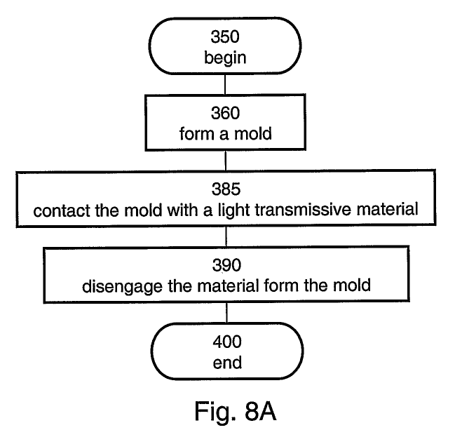

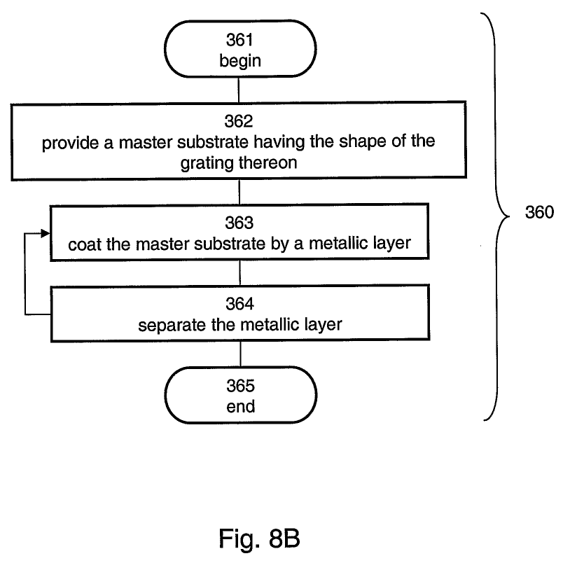

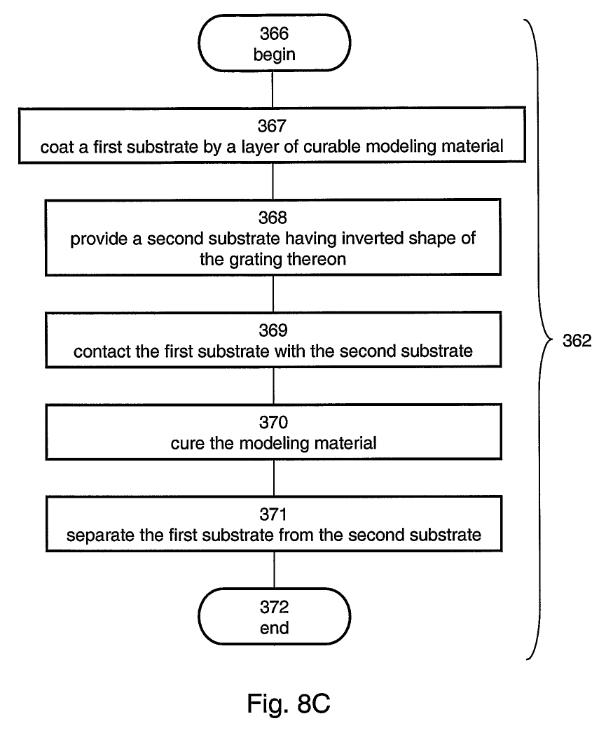

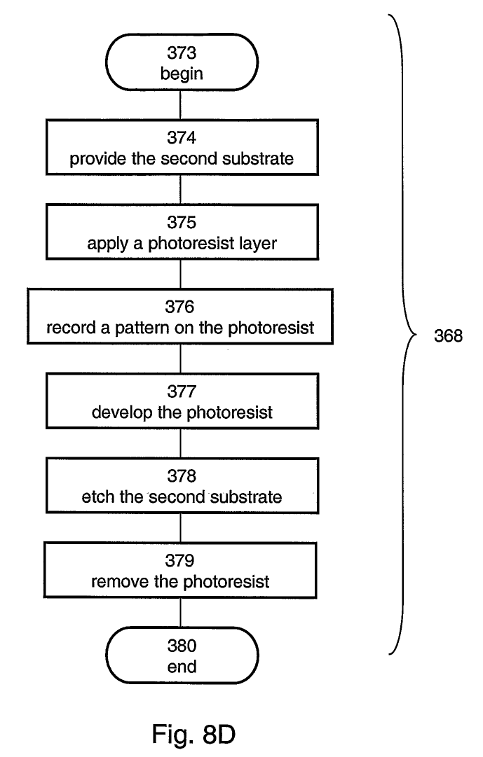

The present embodiments successfully provide a method suitable for manufacturing the optical relay device, in the preferred embodiments in the optical relay device comprises diffraction gratings. The method according to various exemplary embodiments of the present invention is illustrated in the flowchart diagrams of FIGS. 8A-D.

It is to be understood that, unless otherwise defined, the method steps described hereinbelow can be executed either contemporaneously or sequentially in many combinations or orders of execution. Specifically, the ordering of the flowchart diagrams of FIGS. 8A-D is not to be considered as limiting. For example, two or more method steps, appearing in the following description or in the flowchart of FIGS. 8A-D in a particular order, can be executed in a different order (e.g., a reverse order) or substantially contemporaneously. Additionally, several method steps described below are optional and may not be executed.

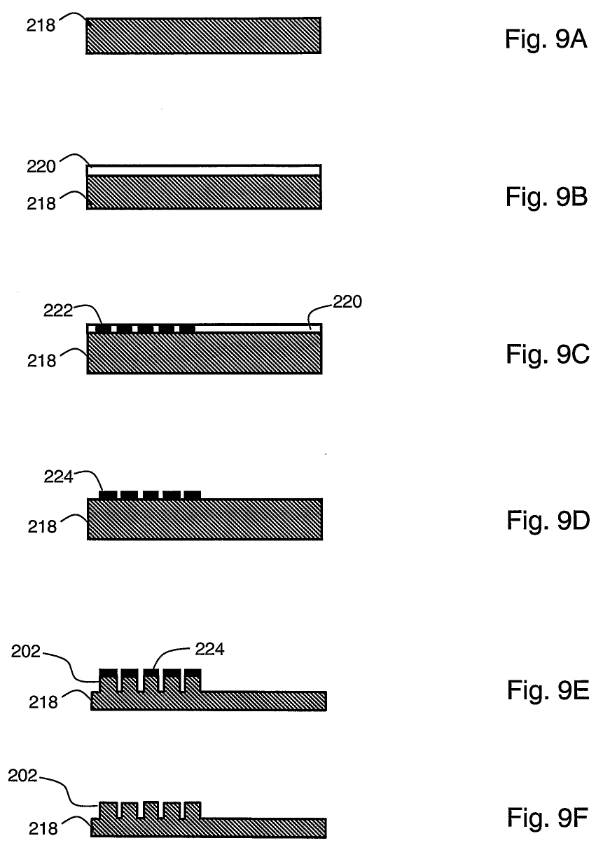

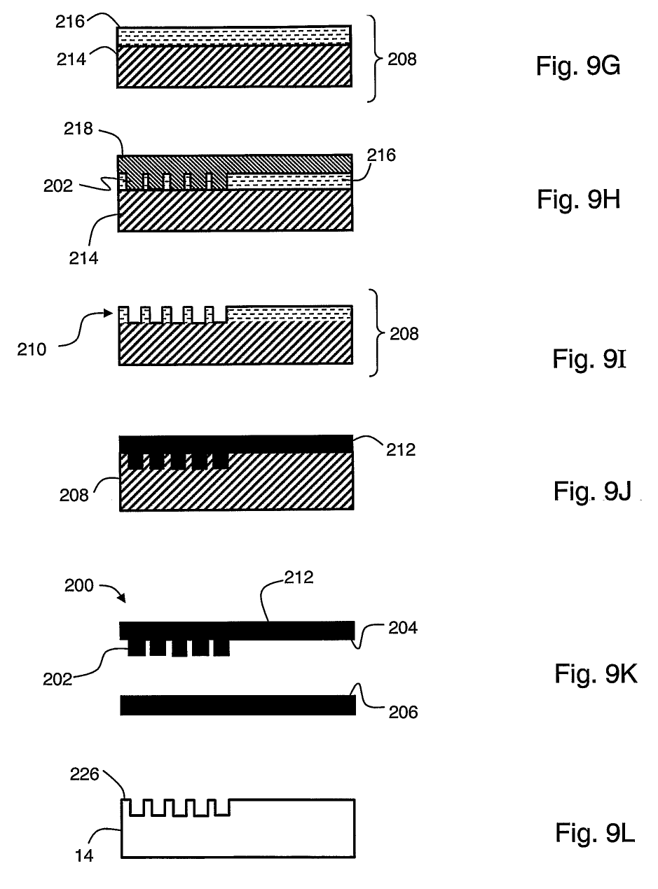

An exemplified process for manufacturing the optical relay device, according to a preferred embodiment of the present invention is provided in the Examples section that follows (see Example 3 and the schematic process illustrations of FIGS. 9A-L).

The method begins at step 350 and continues to step 360 in which a mold having one or more patterns corresponding to an inverted shape of the linear grating is formed. The mold is preferably configured to receive a light transmissive material and to shape the material as a structure such as the structure of substrate 14 described above. Thus, according to the presently preferred embodiment of the invention the mold has a cavity having the desired shape of the light transmissive substrate. The number of patterns equals the number of linear gratings which are to be formed on the substrate of the optical relay device. In various exemplary embodiments of the invention the mold is configured to form additional optical element 150 for reducing optical cross-talks between the input gratings, as further detailed hereinabove. Thus, the cavity of the mold may include element 150 therein or it may be manufactured with an insertion so as to allow assembling element 150 into the apex section of the structure after molding.

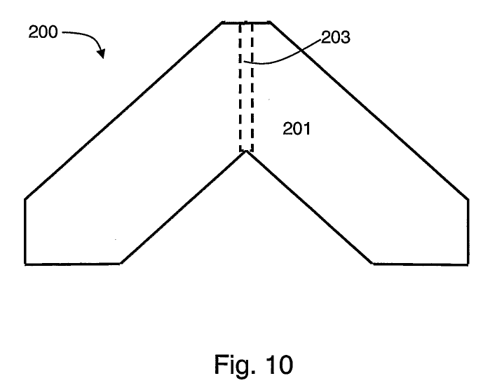

The mold can also be configured to form the gratings on a solid light transmissive substrate coated with one or more layers of materials suitable for three-dimensional object construction. In this embodiment, the mold may be manufactured as a single or double plate mold which contacts the coating and form the grating. The mold can be formed by any technique known in the art. A preferred method for forming the mold is described hereinunder. A schematic illustration of a side view of mold 200 and an inverted shape 202 of one linear grating is provided in FIG. 9K. A schematic illustration of a top view of the cavity 201 of mold 200 is provided in FIG. 10. Also shown in FIG. 10 is an insertion 203 formed within cavity 201, to allow assembling of element 150 after molding.

Mold 200 is preferably made of metal, e.g., nickel or aluminum, and can comprise one or two surfaces, generally shown at 204 and 206. Shown in FIG. 9K is an exemplified configuration in which surface 204 has the inverted shape of the grating while surface 206 is substantially flat. This embodiment is useful when it is desired to manufacture am optical relay in which all the gratings are formed on one surface of the substrate (say, surface 22, see FIG. 2B). When it is desired to form gratings on both surfaces of the optical relay device (surfaces 22 and 24, see FIG. 1A) both surfaces 204 and 206 of mold 200 include the inverted shape of the gratings. Each of surfaces 204 and 206 may have the desired structure (chevron, crescent, etc.) of the light transmissive substrate to be formed.

The method continues to step 385 in which mold 200 is contacted with a light transmissive material. Preferably, the light transmissive material is characterized by a substantially low birefringence. Step 385 can be executed in more than one way.

In one embodiment, an injection molding technique is employed. In this embodiment, the mold is heated while being closed and the light transmissive material is introduced into the mold by injection. The injection of the light transmissive material is performed such as to substantially fill the mold. Once the material is injected to the mold, a high pressure can be applied between the two surfaces of the mold, so as to enhance the surface relief replication.

In another embodiment, an injection compression molding technique is employed. In this embodiment, the mold is heated and the light transmissive material is injected into the mold before the closure of the mold such that the mold is only partially filled. Once the material is injected to the mold, the mold is closed to its final position so as to shape the material according to the shape of the mold. High pressure can be applied between the two surfaces of the mold, so as to enhance the surface relief replication.

In an additional embodiment, a varying temperature protocol is employed. In this embodiment, the mold is first heated to a temperature to above the glass transition temperature of the material. Above this temperature, non-covalent bonds become weak in comparison to the thermal motion, and the material is capable of plastic deformation without fracture. This procedure reduces the internal stresses and the variations in the refractive index of the formed substrate. The advantage of this embodiment is that the high temperature of the mold facilitates optimal filling of the mold and replication of the nano-structures. Subsequently to the heating of the mold, the material is injected into the mold and the temperature of the mold is reduced to allow solidification of the material.

The light transmissive material is hardened within the cavity of the mold and a substrate having the linear grating(s) thereon is thus formed.

The temperatures of the mold and the injected light transmissive material depend, in principle, on the type and amount of material injected into the mold. For example, when the light transmissive material is cycloolefin copolymer or cycloolefin polymer, the melt temperature of the light transmissive material is from about 200° C. to about 320° C. For such materials, fixed temperature protocol can be performed at mold temperature from about 90° C. to about 150° C., and varying temperature protocol can be performed at initial temperature of from about 110° C. to about 180° C., and a final temperature of from about 90° C. to about 140° C.

In still another embodiment, the light transmissive material is in the form of a solid substrate having optically flat surfaces, preferably parallel. In this embodiment, step 385 is preferably preceded by a cutting step in which a light transmissive substrate is cut to form the structure described hereinabove. The substrate can be fabricated in any way known in the art or any of the processes described herein. According to the presently preferred embodiment of the invention, one or more surfaces of the substrate are preferably coated prior to the contacting step with one or more layers of materials suitable for three-dimensional object construction, optionally and preferably including a layer of adhesion promotion material located between the substrate and the molded coat layer. When it is desired to include optical element 150 in the light relay device, the building material is coated selectively so as to facilitate later attachment of element 150. This may be done, for example, by leaving the desired location uncoated, to allow later formation of element 150.

The coating material may be of various types, including, without limitation a modeling material which may solidify to form a solid layer of material upon curing. For example, the substrate can be coated with a material having a photopolymer component curable by the application of electromagnetic radiation. The coated substrate is then pressed against the mold and is irradiated by the curing radiation to cure the layers. The thickness of the modeling material is preferably a few hundreds of microns and the thickness of the adhesion promotion layer is preferably from a few microns to a few tens of microns.

In various exemplary embodiments of the invention the substrate is coated with a material having a curable component, such as a photoinitiator. In these embodiments, once the coated substrate is pressed against the mold, a curing radiation is applied to cure the layers. The curing radiation can be applied through the substrate, or through the mold if it is made of radiation-transparent material. To enhance adhesion of the modeling material to the substrate material, an adhesion promoter can be applied on the surface(s) of the substrate.

The photoinitiator may initiate polymerization of the transmissive material and/or the adhesion promoter.

The term “photoinitiator”, as used herein, refers to a substance which may be chemically activated upon exposure to light, and the chemical activation is directed towards initiating a polymerization process between one or more polymerizable monomers in the material for coating the substrate.

In various exemplary embodiments of the invention the photoinitiator comprises a UV curable component, in which case the curing radiation is a UV radiation having a wavelength ranging from about 100 nm to about 400 nm. For example, the photoinitiator may be activated by UV radiation ranging from approximately 280 nm to approximately 400 nm.

The photoinitiator may be a charge-driven photoinitiator or a free radical-driven photoinitiator, depending on the type of transmissive polymeric materials and/or the adhesion promoter that is used for the substrate coating.

The photoinitiator may form a part of one or more monomers used for the polymer comprising the transmission material, by containing a free radical-driven polymerizable group and/or charge-driven polymerizable group (such as for a cationic ring opening polymerization process). The resulting polymer may therefore contain a UV curable component in the form of special functional groups. Such polymer is then blended with a free radical-driven and/or a charge-driven photoinitiator and processed into the coating layer on the substrate. Upon exposure to the UV radiation, the photoinitiator may produce cations or free radicals, which initiate polymerization of the transmissive polymeric materials and/or the adhesion promoter. For example, in embodiments wherein the transmissive polymeric materials and/or the adhesion promoter include monoacrylate, diacrylates, methacrylate and/or polyacrylate groups, the photoinitiator may be a free radical-driven photoinitiator. In embodiments wherein the transmissive polymeric materials and/or the adhesion promoter include vinyl, cycloolefin, epoxide and/or oxetane groups, a charge-driven photoinitiator may be used. During photolysis, many charge-driven photoinitiators generate free radicals in addition to cations, therefore, a preferred photoinitiator which may be used to initiate polymerization of the transmissive polymeric materials and/or the adhesion promoter, includes a mixture of acrylate or methacrylate groups and vinyl, epoxide, or oxetane groups.

Exemplary free radical-driven photoinitiators include, without limitation: acyloin and derivatives thereof such as benzoin, benzoin methyl ether benzoin ethyl ether, benzoin isopropyl ether, benzoin isobutyl ether, desyl bromide, and α-methylbenzoin; diketones, such as benzil and diacetyl; an organic sulfide, such as diphenyl monosulfide, diphenyl disulfide, desyl phenyl sulfide, and tetramethylthiuram monosulfide; a thioxanthone; an S-acyl dithiocarbamate, such as S-benzoyl-N,N-dimethyldithiocarbamate and S-(p-chlorobenzoyl)-N,N-dimethyldithiocarbamate; a phenone, such as acetophenone, α,α,α-tribromoacetophenone, o-nitro-α,α,α-tribromoacetophenone, benzophenone, and p,p′-tetramethyldiaminobenzophenone; a quinone; a triazole; a sulfonyl halide, such as p-toluenesulfonyl chloride; a phosphorus-containing photoinitiator, such as an acylphosphine oxide; an acrylated amine; 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N,N,N′,N′-tetramethyl-4,4′-diaminobenzophenone, 1-(4-isopropylphenyl)-2-hydroxy-2-methylpropane-1-one, and other thioxanthone compounds; and mixtures thereof.

Exemplary charge-driven photoinitiators include, without limitation: an onium salt, such as a sulfonium salt, an iodonium salt, or mixtures thereof; a bis-diaryliodonium salt, a diaryliodonium salt of sulfonic acid, a triarylsulfonium salt of sulfonic acid, a diaryliodonium salt of boric acid, a diaryliodonium salt of boronic acid, a triarylsulfonium salt of boric acid, a triarylsulfonium salt of boronic acid, or mixtures thereof; diaryliodonium hexafluoroantimonate, aryl sulfonium hexafluorophosphate, aryl sulfonium hexafluoroantimonate, bis(dodecyl phenyl) iodonium hexafluoroarsenate, tolyl-cumyliodonium tetrakis(pentafluorophenyl) borate, bis(dodecylphenyl) iodonium hexafluoroantimonate, dialkylphenyl iodonium hexafluoroantimonate, diaryliodonium salts of perfluoroalkylsulfonic acids, such as diaryliodonium salts of perfluorobutanesulfonic acid, perfluoroethanesulfonic acid, perfluorooctanesulfonic acid, and trifluoromethane sulfonic acid; diaryliodonium salts of aryl sulfonic acids such as diaryliodonium salts of para-toluene sulfonic acid, dodecylbenzene sulfonic acid, benzene sulfonic acid, and 3-nitrobenzene sulfonic acid; triarylsulfonium salts of perfluoroalkylsulfonic acids such as triarylsulfonium salts of perfluorobutanesulfonic acid, perfluoroethanesulfonic acid, perfluorooctanesulfonic acid, and trifluoromethane sulfonic acid; triarylsulfonium salts of aryl sulfonic acids such as triarylsulfonium salts of para-toluene sulfonic acid, dodecylbenzene sulfonic acid, benzene sulfonic acid, and 3-nitrobenzene-sulfonic-acid; diaryliodonium salts of perhaloarylboronic acids, triarylsulfonium salts of perhaloarylboronic acid, and mixtures thereof.

The phrase “adhesion promoter” as used herein refers to a substance which is added to the coating material so as to enhance the adhesion of the coating material to the substrate.

Typically the adhesion promoter comprises one or more types of polymerizable monomers having two or more polymerizable functional groups, which upon polymerization can enhance the adhesion of the coating layer, for example by cross-linking the coating material with the substrate. Additional attributes which the adhesion promoter may bestow on the coating layer include physical properties such as abrasion resistance, backmark retention, proper sliding friction and others. Preferred adhesion promoters, according to embodiments of the present invention include, without limitation, water soluble polymers, hydrophilic colloids or water insoluble polymers, latex or dispersions; styrene and derivatives thereof, acrylic acid or methacrylic acid and derivatives thereof, olefins, chlorinated olefins, cycloolefins, (meth)acrylonitriles, itaconic acid and derivatives thereof, maleic acid and derivatives thereof, vinyl halides, vinylidene halides, vinyl monomer having a primary amine addition salt, vinyl monomer containing an aminostyrene addition salt, polyurethanes and polyesters and others; and mixtures thereof. Also included are adhesion promoting polymers such as disclosed in, for example, U.S. Pat. Nos. 6,171,769 and 6,077,656.

When using an adhesion promoter, the layer coating the substrate is subsequently crosslinked by exposure to UV radiation and then may be further set thermally.

In an additional embodiment, one or more surfaces of the substrates are coated with one or more layers of a soft thermally settable material. The mold is heated and the coated substrate is then pressed against the mold to thermally set (harden) the thermally settable material. To enhance adhesion, an adhesion promoter can be applied on the surface(s) of the substrate.

Thermally settable polymers are known in the art and found, e.g., in U.S. Pat. Nos. 6,197,486, 6,197,486, 6,207,361, 6,436,619, 6,465,140 and 6,566,033. Suitable classes of thermally settable polymers according to the present invention include polymers of alpha-beta unsaturated monomers, polyesters, polyamides, polycarbonates, cellulosic esters, polyvinyl resins, polysulfonamides, polyethers, polyimides, polyurethanes, polyphenylenesulfides, polytetrafluoroethylene, polyacetals, polysulfonates, polyester ionomers, and polyolefin ionomers. Interpolymers and/or mixtures thereof. Exemplary polymers of alpha-beta unsaturated monomers include polymers of ethylene, propylene, hexene, butene, octene, vinylalcohol, acrylonitrile, vinylidene halide, salts of acrylic acid, salts of methacrylic acid, tetrafluoroethylene, chlorotrifluoroethylene, vinyl chloride, and styrene.

In various exemplary embodiments of the invention the method continues to step 390 in which the substrate is disengaged from the mold. FIG. 9L schematically illustrates the substrate 14 and an exemplified linear grating 226 formed thereon, after the disengagement of the substrate from the mold.

The method ends at step 400.

Reference is now made to FIG. 8B which is a flowchart diagram further detailing a method suitable for forming the mold (step 360 in FIG. 8A), according to various exemplary embodiments of the present invention. The method begins at step 361 and continues to step 362 in which a master substrate 208 having the shape 210 of the gratings form thereon is provided (see FIG. 9I). A preferred method for forming such master substrate is described hereinunder.

The method continues to step 363 in which master substrate 208 is coated by one or more metallic layers 212 (see FIG. 9J). The metallic layers can be made of any metal suitable for forming molds, such as, but not limited to, aluminum, nickel or any other suitable metal alloy as known in the art. The metallic layer(s) can be applied by any technique known in the art, including, without limitation, physical vapor deposition (PVD), chemical vapor deposition (CVD), atomic layer deposition (ALD), electrochemical plating (ECP) or combination thereof. In the case of more than one metallic layers, the first layer can be deposited formed by PVD, ALD and the other layers can be electroplated on the first layer.

Any of the above coating techniques are well known to those skilled in the art of coating and thin film deposition. In CVD, for example, the metallic layers are formed by placing the master substrate in a mixture of gases. Under certain pressure and temperature conditions, the molecules contained in the gases are deposited on the surfaces of the master substrate as a result of thermal reactions to form the metallic layer thereupon. CVD process can be done in a conventional CVD reactor such as, for example, the CVD reactor disclosed in U.S. Pat. Nos. 5,503,875, 5,441,570, and 6,983,620.

In ALD, the metallic layers are formed on the master substrate by chemically sorbing one or more precursors which comprise the desired metal and a ligand onto the master substrate surface to form a monolayer of precursors that is approximately one molecule thick. A second precursor may be introduced to chemically react with the first chemisorbed layer to grow a thin film on the master substrate surface. After sufficient process cycles of monolayer formation has occurred, or alternatively with the formation of the monolayers, the monolayers can be contacted with a reaction gas to form the metallic layer on the surface of the master substrate. ALD process can be done in any ALD reactor such as, for example, the ALD reactor disclosed in U.S. Pat. Nos. 6,787,463, 6,808,978, 6,869,876 and 7,037,574.

In PVD, the metallic layers are deposited on the master substrate by physical, as opposed to chemical, means. Typically, the deposition of the metallic layer is by sputtering, in which ions are created by collisions between gas atoms and electrons in a glow discharge. The ions are accelerated and directed to a cathode of sputter target material by an electromagnetic field causing atoms of the sputter target material to be ejected from the cathode surface, thereby forming sputter material plasma. By contacting the master substrate with the plasma, the metallic layers are deposited on the surface of the master substrate. PVD process can be done in any conventional magnetron, such as the magnetron disclosed in U.S. Pat. Nos. 4,441,974, 4,931,158, 5,693,197 and 6,570,172.

In ECP, a seed layer is first formed over the surface of the master substrate and subsequently the master substrate is exposed to an electrolyte solution while an electrical bias is simultaneously applied between the master substrate and an anode positioned within the electrolyte solution. The electrolyte solution is generally rich in ions to be plated onto the surface of the master substrate. Therefore, the application of the electrical bias causes the ions to be urged out of the electrolyte solution and to be plated onto the seed layer. ECP process can be done in any way known in the art such as, for example, the techniques disclosed in U.S. Pat. Nos. 6,492,269, 6,638,409, 6,855,037 and 6,939,206.

The method continues to step 364 in which metallic layer or layers 212 are separated from the master substrate 208 to form one surface (e.g., surface 204) of mold 200. In the embodiment in which both surfaces of the mold are patterned according to the inverted shape of the linear grating, the method loops back to step 363 to fabricate the other surface.

The method for forming the mold ends at step 365.

Reference is now made to FIG. 8C which is a flowchart diagram of a method for forming a master substrate, according to various exemplary embodiments of the present invention. The master substrate can be used for forming the mold as described above.

The method begins at step 366 and continues to step 367 in which a first substrate 214 (see FIG. 9G) is coated by one or more layers 216 of a curable modeling material. First substrate is preferably made of a hard material, such as, but not limited to, glass, fused silica, hard plastic, metal and the like. The method continues to step 368 in which a second substrate 218 having the inverted shape 202 of the linear grating is provided. Second substrate 218 is also made of hard material, such as, but not limited to, fused silica, quartz, borosilicate and the like. Second substrate 218 can be fabricated using any technique known in the art for forming either holographic or ruled diffraction gratings.

Thus, substrate 218 can be manufactured classically with the use of a ruling engine, e.g., by burnishing grooves with a diamond stylus in substrate 218, or holographically through a combination of photolithography and etching. A preferred method for forming the second substrate by lithography followed by etching is described hereinunder.

The curable modeling material is capable of solidifying to form a solid layer of material upon curing, as described above. The curable modeling material serves for hosting the shape 210 of the gratings, and is preferably selected to facilitate the aforementioned separation of the metallic layer from the master substrate. In this respect, the hardness of the modeling material in its cured state is preferably lower than the hardness of the metallic layer(s) 212. Additionally, the hardness of the modeling material in its cured state is preferably lower than the hardness of second substrate 218. In various exemplary embodiments of the invention the curable modeling material comprises a UV curable component.

The method continues to step 369 in which first substrate 214 is contacted with second substrate 218 (see FIG. 9H). The method continues to step 370 in which the modeling material is cured. The curing procedure depends on the type of modeling material. For example, when the material is curable by certain electromagnetic radiation (e.g., UV radiation), the curing is by applying the electromagnetic radiation. When the material is curable by thermal treatment, the curing is by thermal treatment, e.g., heating.

The method continues to step 371 in which first substrate 214 is separated from second substrate 218 to expose the cured layer on first substrate 214, thereby forming the master substrate 208 having the shape 210 of the gratings (see FIG. 9I).

The method for forming the master substrate ends at step 372.

Reference is now made to FIG. 8D which is a flowchart diagram of a method for forming a substrate having the inverted shape of the linear grating, according to various exemplary embodiments of the present invention. This method is useful for providing the second substrate 218 (see step 368 in FIG. 8C) which is employed in the preferred manufacturing process of master substrate 208.

The method begins at step 373 and continues to step 374 in which the second substrate 218, which, as stated is preferably made of a hard material, is provided (see FIG. 9A). The method continues to step 375 in which a layer 220 of a photoresist material is applied on substrate 218 (see FIG. 9B).

A photoresist material is a material whose intermolecular bonds are either strengthened or weakened by exposure to certain type of radiation, such as electromagnetic radiation or particle (e.g., electron) beam.

The photoresist material can be applied using any known procedure, such as, but not limited to, coating, printing and lamination. Representative examples of coating procedures include, without limitation, dip coating, roller coating, spray coating, reverse roll coating, spinning or brushing. Representative examples of printing procedures include, without limitation curtain printing or screen printing. The photoresist material used in accordance with the present embodiments may be any material used as a photoresist in the manufacture of diffraction gratings.

The photoresist material can be an organic or an inorganic photoresist material in a liquid or dry form. The photoresist material can be a positive photoresist material or a negative photoresist material. A positive photoresist material is a material that becomes, as a result of the exposure step that follows, non-resistant to the subsequent development step as described hereinbelow. Conversely, a negative photoresist material is a material that becomes, as a result of the exposure step that follows, resistant to the development step that follows.

The method continues to step 376 in which a pattern 222 is recorded on layer 220 (see FIG. 9C). The pattern can correspond to the shape of the linear grating or an inverted shape thereof, depending whether the photoresist material is a negative photoresist material or a positive photoresist material. Since it is desired to form an inverted shape of the grating on the surface of substrate 218, when a positive photoresist is used, the standing wave pattern corresponds to the shape of the linear grating, and when a negative photoresist is used, the pattern corresponds to the inverted shape of the grating.

The pattern can be recorded by means of optical interference, e.g., by forming a standing wave interference pattern of two plane optical waves on layer 220. Alternatively, the pattern can be recorded by means of a scanning electron beam.

Representative examples of photoresist materials suitable for electromagnetic radiation include, without limitation, Microposit S1805, commercially available from Shipley Corporation, USA. For such photoresist, the preferred recording is by electromagnetic radiation at a wavelength of 365 nm. Representative examples of photoresist materials suitable for electron beam include, without limitation, polymethyl methacrylate or derivatives thereof.

The method continues to step 377 in which the photoresist is developed thereby forming a mask pattern 224 of developed photoresist on the surface of substrate 218 (see FIG. 9D). The method proceeds to step 378 in which substrate 218 is etched, to form ridges and grooves according to the inverted shape 202 of the grating (see FIG. 9E).

The etching process can be any wet or dry etching process known in the art. The wet etching process can include isotropic etchants or anisotropic etchants. The dry etching process can be purely chemical, purely physical or a combination of chemical and physical etching. Suitable dry etching process thus includes, without limitation, chemical dry etching, ion beam etching, reactive ion etching (also known as chemical-physical etching) and laser induced etching.

Once the inverted shape 202 of the grating is formed, the method optionally and preferably continues to step 379 in which mask pattern 224 is removed (see FIG. 9F).

The method for forming substrate 218 ends at step 380.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Example 1

### Diffraction of Red Light

Following is a non-limiting example in which planar dimension calculations are performed in accordance with the teachings of the preferred embodiments of the invention for the diffraction of red light.

The present calculations are for 509 nm period gratings formed in a light transmissive substrate having index of refraction of 1.522, thickness of 2 mm, and apex angle of δ=62°. As a representative example for red light, a wavelength of 615 nm was assumed.

With the above values of the grating period, index of refraction and wavelength a horizontal field-of-view Ω_{y} of [−12.0°, +12.0°] and a transverse field-of-view Ωₓ of [−9.0°, +9.0°] can be achieved. The overall (diagonal) field-of-view Ω is calculated using Equation 5 to obtain Ω=[−15°, +15°].

For Δz=25 mm, the minimal dimensions of the output optical element(s) are (see Equation 6) L_{O, min}=10.6 mm and W_{O, min}=7.9 mm. For L_{EB}=4 mm, W_{EB}=1 mm and Oₚ=3 mm, the dimensions of the output optical element(s) are (see Equation 7) L_{O}=17.6 mm and W_{O}=11.9 mm.

Using the thickness of the substrate and the above values of Ω_{y} one obtains a hop-length of h=3.5 mm which is then used to set the length L_{I} of the input element to be from about 3.5 mm to about 10.5 mm.

The above values of Ωₓ and Ω_{y} correspond to an outermost propagation angle (as projected on the ξ-η plane and measured from the η direction) of −12° and +10°. Thus, in accordance with preferred embodiments of the present invention, the value of the angular parameters are γ₁=90°−(62°−12°)=40°, and γ₂=90°−(62°+10°)=18°.

For Δy=19.2 mm, L_{I}=4 mm, and the above values of δ, γ₁, γ₂, W_{O} and L_{O}, the width W_{I} of the input optical element is (see Equation 8) is W_{I}=35.2 mm.

### Example 2

### Diffraction of Blue Light

Following is a non-limiting example in which planar dimension calculations are performed in accordance with the teachings of the preferred embodiments of the invention for the diffraction of blue light.

The present calculations are for 370 nm period gratings formed in a light transmissive substrate having index of refraction of 1.529, thickness of 1.8 mm, and apex angle of δ=60°. As a representative example for blue light, a wavelength of 465 nm was assumed.

With the above values of the grating period, index of refraction and wavelength a horizontal field-of-view Ω_{y} of [−12°, +12°] and a transverse field-of-view Ωₓ of [−9°, +9°] can be achieved. The overall (diagonal) field-of-view Ω is calculated using Equation 5 to obtain Ω=[−15°, +15°].

For Δz=20 mm, the minimal dimensions of the output optical element(s) are L_{O, min}=7.8 mm and W_{O,min}=5.8 mm. For L_{EB}=5 mm, W_{EB}=2 mm and Oₚ=3 mm the dimensions of the output optical element(s) are L_{O}=15.8 mm and W_{O}=10.8 mm.

Using the thickness of the substrate and the above values of Ω_{y} one obtains a hop-length of h=3.1 mm, which is then used to set the length L_{I} of the input element to be from about 3 mm to about 10 mm.

The above values of Ωₓ and Ω_{y} correspond to an outermost propagation angle (as projected on the ξ-η plane and measured from the η direction) of −11.6° and +9.9°. Thus, in accordance with preferred embodiments of the present invention, the value of the angular parameters are θ₁=90°−(60−11.6)=41.6°, and γ₂=90°−(60°+9.9π)=20.1°.

For Δy=20.1 mm, L_{I}=4 mm, and the above values of δ, γ₁, γ₂, W_{O} and L_{O}, the width W_{I} is 33.9 mm.

### Example 3

### A Detailed Manufacturing Process

FIGS. 9A-L illustrate an exemplified embodiment for manufacturing the optical relay device according to the teachings of the present invention.

FIG. 9A schematically illustrates second substrate 218, which is preferably used for manufacturing the master substrate as further detailed hereinabove.

FIG. 9B schematically illustrates second substrate 218, once layer 220 of photoresist material is applied thereon.

FIG. 9C schematically illustrates second substrate 218, once pattern 222 is recorded on layer 220

FIG. 9D schematically illustrates second substrate 218, once the photoresist is developed to form mask pattern 224 on layer the surface of substrate 218.

FIG. 9E schematically illustrates substrate 218 following the etching process which forms the inverted shape 202 of the grating on substrate 218.

FIG. 9F schematically illustrates substrate 218 following once mask pattern 224 is removed.

FIG. 9G schematically illustrates first substrate 214, which is also used for manufacturing the master substrate as further detailed hereinabove. Substrate 214 is coated by one or more layers 216 of a curable modeling material.

FIG. 9H schematically illustrates the contact between first substrate 214 and second substrate 218. As shown, the modeling material receives the shape of the gratings.

FIG. 9I illustrate master substrate 208, which is formed after the separation of first substrate 214 from second substrate 218.

FIG. 9J illustrate master substrate 208 once one or more metallic layers 212 are applied thereon. The metallic layers serve as a surface of the mold as further detailed hereinabove.

FIG. 9K schematically illustrates mold 200 with a first surface 204 and a second surface 206. First surface is formed by separating metallic layer 212 from master substrate 208. In the present example, second surface 206 is flat, but, as stated, it can be manufactured similarly to surface 204 to include inverted shape of one or more gratings.

FIG. 9L schematically illustrates substrate 14 and grating 226 formed using mold 200.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. An optical relay device for a binocular device which can be held or mounted in front of the eyes of a user, comprising:
a planar light-transmissive substrate shaped as an open planar structure having a right section, a left section and an apex section connecting said right and said left sections, wherein the left and right sections are non-parallel, such that said right and said left sections are separated by an air gap;
at least two input optical elements located at said apex section;
a right output optical element located at said right section; and
a left output optical element located at said left section;
said substrate and said optical elements being designed and constructed such that light is redirected by said input optical elements to propagate via total internal reflection within at least one of said left and said right sections in the direction of at least one of said left and said right output optical elements, and is redirected out of said light-transmissive substrate by said at least one of said left and said right output optical elements.

2. A system for generating and transmitting an image, comprising the optical relay device of claim 1, and an image generating system for providing the optical relay device with collimated light constituting the image.

3. The device of claim 1, wherein each of said optical elements comprises a linear grating.

4. (canceled)

5. The device of claim 1, wherein the device further comprises an additional optical element positioned at said apex section and configured for reducing optical cross-talks between said at least two input optical elements.

6. A method of manufacturing an optical relay device for a binocular device which can be held or mounted in front of the eyes of a user, comprising:
forming a mold configured to receive a light transmissive material and to shape said material as an open planar structure having a right section, a left section and an apex section connecting said right and said left sections, wherein said left and right sections are non-parallel such that said right and said left sections are separated by an air gap, said mold being patterned according to inverted shapes of:
(i) at least two central input optical elements being linear gratings located at said apex section and characterized by periodic linear structures having similar periods and different orientations,
(ii) a right output optical element being a linear grating located at said right section, and
(iii) a left output optical element being a linear grating located at said left section; and
contacting said mold with said light transmissive material, so as to provide a light-transmissive substrate shaped as said structure and formed with said at least two central linear gratings, said right linear grating and said left linear grating.

7. The method of claim 6, wherein said mold is configured to form an additional optical element at said apex section, said additional optical element being configured for reducing optical cross-talks between said at least two central linear gratings.

8. A method of manufacturing an optical relay device for a binocular device which can be held or mounted in front of the eyes of a user, comprising:
cutting a light transmissive substrate to form an open planar structure having a right section, a left section and an apex section connecting said right and said left sections, wherein said left and right sections are non-parallel, such that said right and said left sections are separated by an air gap;
forming a mold patterned according to an inverted shape of at least one linear grating; and
contacting said at least one mold with said structure formed from said light transmissive substrate, so as to form
(i) at least two central input optical elements being linear gratings located at said apex section and characterized by periodic linear structures having similar periods and different orientations,
(ii) a right output optical element being a linear grating located at said right section, and
(iii) a left output optical element being a linear grating located at said left section.

9. The method of claim 8, further comprising attaching an additional optical element to said light transmissive substrate at said apex section, said additional optical element being configured for reducing optical cross-talks between said at least two central linear gratings.

10. The method of claim 6, wherein said at least two central linear gratings are designed and constructed as input optical elements capable of redirecting light rays striking said light transmissive substrate into said light transmissive substrate such that at least one light ray of said light rays propagates within said light-transmissive substrate via total internal reflection.

11. The method of claim 6, wherein said at least two central linear gratings comprise blazed linear gratings.

12. The method of claim 10, wherein each of said right and said left linear gratings are designed and constructed as output optical elements capable of redirecting light rays propagating within said light transmissive substrate out of said light transmissive substrate.

13. The device of claim 5, wherein said additional optical element comprises a light absorber.

14. The device of claim 5, wherein said additional optical element comprises a light scatterer.

15. The device of claim 5, wherein said additional optical element comprises a light diffuser.

16-17. (canceled)

18. The device of claim 3, wherein said at least two input linear gratings comprise a right input linear grating and a left input linear grating, and wherein said right input linear grating and said left input linear grating are characterized by periodic linear structures having similar periods and different orientations.

19. The device of claim 3, wherein said at least two input linear gratings comprise a left input linear grating, and wherein said left input linear grating and said left output linear grating are characterized by periodic linear structures having similar periods and similar orientations.

20. The device of claim 3, wherein said at least two input linear gratings comprise a right input linear grating, and wherein said right input linear grating and said right output linear grating are characterized by periodic linear structures having similar periods and similar orientations.

21. The device of claim 1, wherein said left output optical element is designed and constructed for redirecting light striking said light transmissive substrate at any angle within a predetermined field-of-view out of said light-transmissive substrate; and said right output optical element is designed and constructed for redirecting light striking said light transmissive substrate at any angle within said predetermined field-of-view out of said light-transmissive substrate.

22. The device of claim 21, wherein each of said left and said right output optical element is characterized by planar dimensions selected such that at least a portion of at least one outermost light ray within said predetermined field-of-view is redirected by said left output optical element into a first two-dimensional region, and at least a portion of at least one outermost light within said predetermined field-of-view is redirected by said right output optical element into a second two-dimensional region, said first and said second two-dimensional regions being at a predetermined distance from said light transmissive substrate.

23. The device of claim 1, wherein said left output optical element is designed and constructed for redirecting light striking said light transmissive substrate at any angle within a first partial field-of-view out of said light-transmissive substrate; and said right output optical element is designed and constructed for redirecting light striking said light transmissive substrate at any angle within a second partial field-of-view out of said light-transmissive substrate.

24. The device of claim 23, wherein said first partial field-of-view and said second partial field-of-view are different.

25. (canceled)

26. The device of claim 23, wherein said left output optical element is characterized by planar dimensions selected such that at least a portion of at least one outermost light ray within said first partial field-of-view is directed to a first two-dimensional region, and wherein said right output optical element is characterized by planar dimensions selected such that at least a portion of at least one outermost light ray within said second partial field-of-view is directed to a second two-dimensional region, said first and said second two-dimensional regions being at a predetermined distance from said light transmissive substrate.

27-34. (canceled)

35. The device of claim 22, wherein a width along a vertical axis characterizing the planar dimensions of said right and said left output optical elements is smaller than a width along said vertical axis characterizing the planar dimensions of said input optical element.

36-41. (canceled)

42. A method of manufacturing an optical relay device, comprising:
forming a mold configured to receive a light transmissive material and to shape said material as an open planar structure having a right section, a left section and an apex section connecting said right and said left sections such that said right and said left sections are separated by an air gap, said mold being patterned according to inverted shapes of:
(i) at least two central input optical elements being linear gratings located at said apex section,
(ii) a right output optical element being a linear grating located at said right section, and
(iii) a left output optical element being a linear grating located at said left section; and
contacting said mold with said light transmissive material, so as to provide a light-transmissive substrate shaped as said structure and formed with said at least two central linear gratings, said right linear grating, said left linear grating and an additional optical element at said apex section, wherein said additional optical element is configured for reducing optical cross-talks between said at least two central linear gratings.

43. A method of manufacturing an optical relay device, comprising:
cutting a light transmissive substrate to form an open planar structure having a right section, a left section and an apex section connecting said right and said left sections such that said right and said left sections are separated by an air gap;
forming a mold patterned according to an inverted shape of at least one linear grating; and
contacting said at least one mold with said structure formed from said light transmissive substrate, so as to form
(i) at least two central input optical elements being linear gratings located at said apex section,
(ii) a right output optical element being a linear grating located at said right section, and
(iii) a left output optical element being a linear grating located at said left section; and
attaching an additional optical element to said light transmissive substrate at said apex section, said additional optical element being configured for reducing optical cross-talks between said at least two central linear gratings.
